(19) United States
(12) Patent Application Publication
(10) Pub. No.: US 2025/0106669 A1
(43) Pub. Date: Mar. 27, 2025

(54) REPORTING CHANNEL STATE INFORMATION ASSOCIATED WITH SUB-CONFIGURATIONS

(71) Applicant: Samsung Electronics Co., Ltd., Suwon-si (KR)

(72) Inventor: Jeongho Jeon, San Jose, CA (US)

(21) Appl. No.: 18/885,291

(22) Filed: Sep. 13, 2024

Related U.S. Application Data
(60) Provisional application No. 63/540,576, filed on Sep. 26, 2023.
(60) Provisional application No. 63/545,682, filed on Oct. 25, 2023.
(60) Provisional application No. 63/547,236, filed on Nov. 3, 2023.

(51) Int. Cl. H04W 24/10; H04L 5/00

(52) U.S. Cl. CPC H04W 24/10; H04L 5/0051

(57) ABSTRACT

Methods and apparatuses for reporting channel state information (CSI) associated with sub-configurations in wireless communication systems. A method includes receiving information related to non-zero power CSI reference signals (NZP CSI-RSs) for channel measurement and CSI-RSs or CSI interference measurements (CSI-RSs/CSI-IMs) for interference measurement on a cell and information related to a CSI report associated with CSI report sub-configurations. The method further includes receiving information related to indicating CSI report sub-configurations from the CSI report sub-configurations, and the NZP CSI-RSs for channel measurement and the one or more CSI-RSs/CSI-IMs for interference measurement. The method further includes determining a CSI sub-reports corresponding to the CSI report sub-configurations, respectively, based on the reception of the NZP CSI-RSs for channel measurement and the one or more CSI-RSs/CSI-IMs for interference measurement and transmitting an uplink channel with the CSI report including the CSI sub-reports.

### CROSS-REFERENCE TO RELATED APPLICATIONS AND CLAIM OF PRIORITY

The present application claims priority to:
U.S. Provisional Patent Application No. 63/540,576, filed on Sep. 26, 2023;
U.S. Provisional Patent Application No. 63/545,682, filed on Oct. 25, 2023; and
U.S. Provisional Patent Application No. 63/547,236, filed on Nov. 3, 2023.
   The contents of the above-identified patent documents are incorporated herein by reference.

### TECHNICAL FIELD

The present disclosure relates generally to wireless communication systems and, more specifically, the present disclosure relates to reporting channel state information (CSI) associated with sub-configurations in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to reporting CSI associated with sub-configurations in wireless communication systems.

In one embodiment, a method for a user equipment (UE) to report CSI is provided. The method includes receiving first information related to one or more non-zero power CSI reference signals (NZP CSI-RSs) for channel measurement and one or more CSI-RSs or CSI interference measurements (CSI-RSs/CSI-IMs) for interference measurement on a cell and second information related to a CSI report associated with a first number of CSI report sub-configurations. The first number of CSI report sub-configurations are associated with a first number of subsets of the one or more NZP CSI-RSs for channel measurement, respectively. Subsets in the first number of subsets of the one or more NZP CSI-RSs for channel measurement are identical or have no intersection. The method further includes receiving third information related to indicating a second number of CSI report sub-configurations from the first number of CSI report sub-configurations, and the one or more NZP CSI-RSs for channel measurement and the one or more CSI-RSs/CSI-IMs for interference measurement. The indication for second number of sub-configurations is explicit or implicit depending on a CSI report type. The method further includes determining a second number of CSI sub-reports corresponding to the second number of CSI report sub-configurations, respectively, based on the second information, the third information, and the reception of the one or more NZP CSI-RSs for channel measurement and the one or more CSI-RSs/CSI-IMs for interference measurement and transmitting an uplink channel with the CSI report including the second number of CSI sub-reports.

In another embodiment, a UE is provided. The UE includes a transceiver configured to receive first information related to one or more NZP CSI-RSs for channel measurement and one or more CSI-RSs/CSI-IMs for interference measurement on a cell and second information related to a CSI report associated with a first number of CSI report sub-configurations. The first number of CSI report sub-configurations are associated with a first number of subsets of the one or more NZP CSI-RSs for channel measurement, respectively. Subsets in the first number of subsets of the one or more NZP CSI-RSs for channel measurement are identical or have no intersection. The transceiver is further configured to receive third information related to indicating a second number of CSI report sub-configurations from the first number of CSI report sub-configurations and the one or more NZP CSI-RSs for channel measurement and the one or more CSI-RSs/CSI-IMs for interference measurement. The indication for second number of sub-configurations is explicit or implicit depending on a CSI report type. The UE further includes a processor operably coupled with the transceiver. The processor is configured to determine a second number of CSI sub-reports corresponding to the second number of CSI report sub-configurations, respectively, based on the second information, the third information, and the reception of the one or more NZP CSI-RSs for channel measurement and the one or more CSI-RSs/CSI-IMs for interference measurement. The transceiver is further configured to transmit an uplink channel with the CSI report including the second number of CSI sub-reports.

In yet another embodiment, a base station (BS) is provided. The BS includes a processor and a transceiver operably coupled with the processor. The transceiver is configured to transmit first information related to one or more NZP CSI-RSs for channel measurement and one or more CSI-RSs/CSI-IMs for interference measurement on a cell and transmit second information related to a CSI report associated with a first number of CSI report sub-configurations. The first number of CSI report sub-configurations are associated with a first number of subsets of the one or more NZP CSI-RSs for channel measurement, respectively. Subsets in the first number of subsets of the one or more NZP CSI-RSs for channel measurement are identical or have no intersection. The transceiver is further configured to transmit third information related to indicating a second number of CSI report sub-configurations from the first number of CSI report sub-configurations, transmit the one or more NZP CSI-RSs for channel measurement and the one or more CSI-RSs/CSI-IMs for interference measurement, and receive an uplink channel with the CSI report including a second number of CSI sub-reports corresponding to the second number of CSI report sub-configurations, respectively, that are based on the second information, the third information, and the one or more NZP CSI-RSs for channel measurement and the one or more CSI-RSs/CSI-IMs for interference measurement. The indication for second number of sub-configurations is explicit or implicit depending on a CSI report type.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate example of wireless transmit and receive paths according to various embodiments of the present disclosure;

FIG. 6 illustrates an example of antenna structure according to various embodiments of the present disclosure;

FIG. 7 illustrates an example of a cell DTX/DRX according to various embodiments of the present disclosure;

FIG. 8 illustrates an example of spatial element adaptation according to various embodiments of the present disclosure;

FIG. 9 illustrates a flowchart of a UE method for sending multiple CSI reports according to various embodiments of the present disclosure;

FIG. 10 illustrates an example of association of CSI-RS resources with CSI report sub-configurations according to various embodiments of the present disclosure;

FIG. 11 illustrates a flowchart of a UE method for determining CSI reference resource and CSI according to various embodiments of the present disclosure;

FIG. 12 illustrates a flowchart of a UE method for determining the transmission of CSI report during cell DRX off-duration according to various embodiments of the present disclosure;

FIG. 13 illustrates a flowchart of a UE method for determining the transmission of aperiodic CSI report during cell DRX off-duration according to various embodiments of the present disclosure; and

FIG. 14 illustrates a flowchart of a UE method for reporting CSI associated with sub-configurations based on a common CSI-RS resource indicator (CRI) according to various embodiments of the present disclosure.

### DETAILED DESCRIPTION

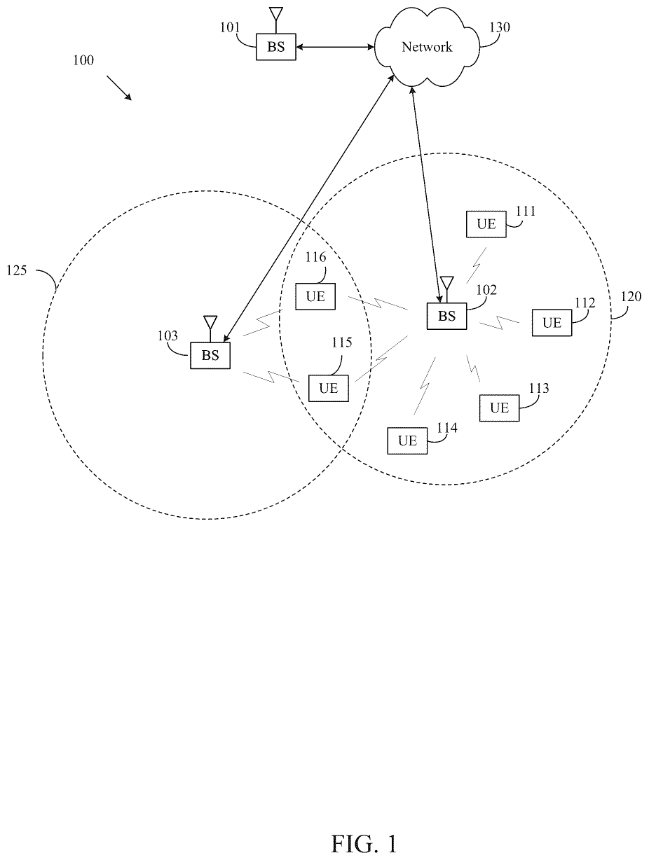

FIG. 1 through FIG. 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v17.5.0, “NR; Physical channels and modulation”; 3GPP TS 38.212 v17.5.0, “NR; Multiplexing and channel coding”; 3GPP TS 38.213 v17.5.0, “NR; Physical layer procedures for control”; 3GPP TS 38.214 v17.5.0, “NR; Physical layer procedures for data”; 3GPP TS 38.331 v17.4.0, “NR; Radio Resource Control (RRC) protocol specification”; and 3GPP TS 38.321 v17.4.0, “NR; Medium Access Control (MAC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the gNBs 101-103 includes circuitry, programing, or a combination thereof, to support reporting CSI associated with sub-configurations in wireless communication systems. Additionally, one or more of the UEs 111-116 includes circuitry, programing, or a combination thereof, for reporting CSI associated with sub-configurations in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

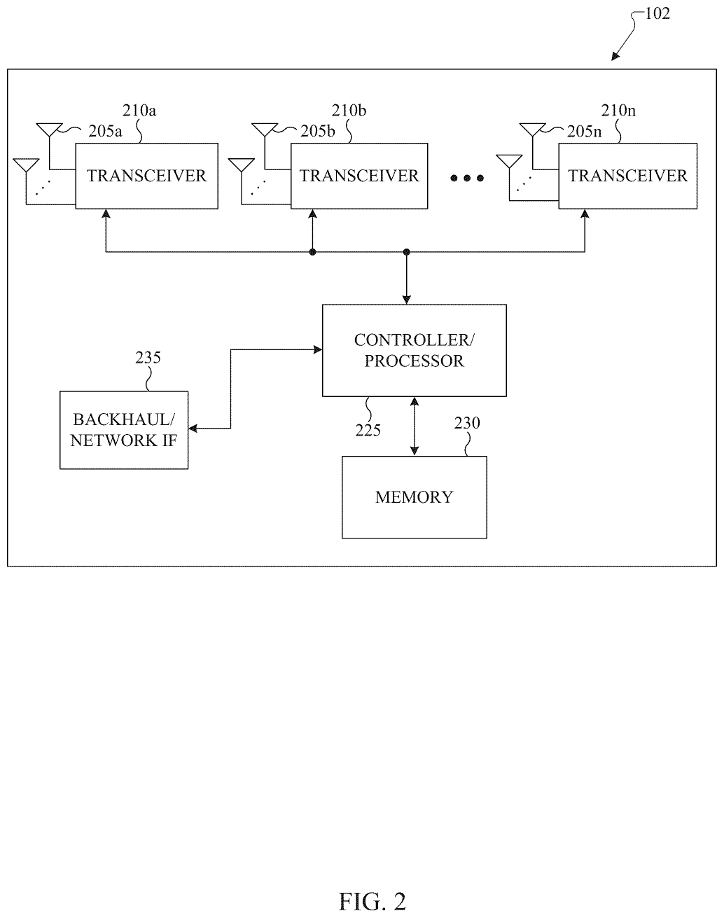

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support CSI reporting associated with sub-configurations in wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

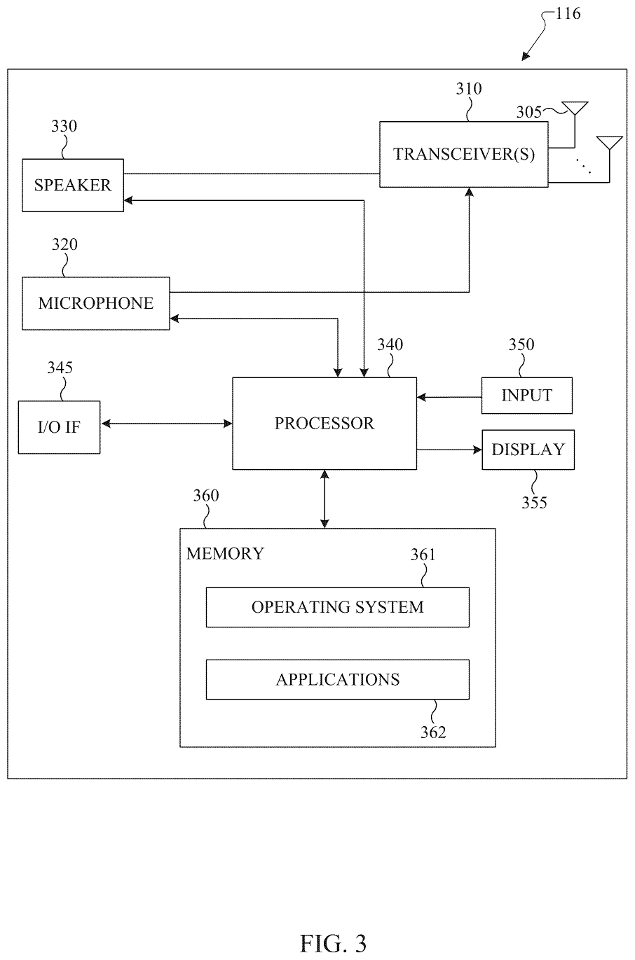

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

In various embodiments, the processor 340 may execute processes to perform reporting of CSI associated with sub-configurations in wireless communication systems as described in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

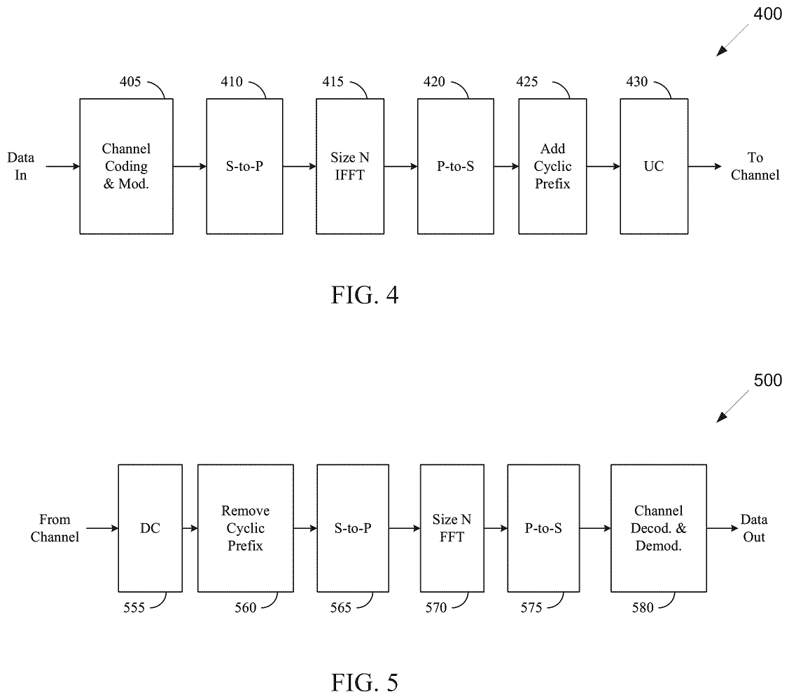

FIG. 4 and FIG. 5 illustrate example wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to flexible synchronization signal and system information transmission in wireless communication systems.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

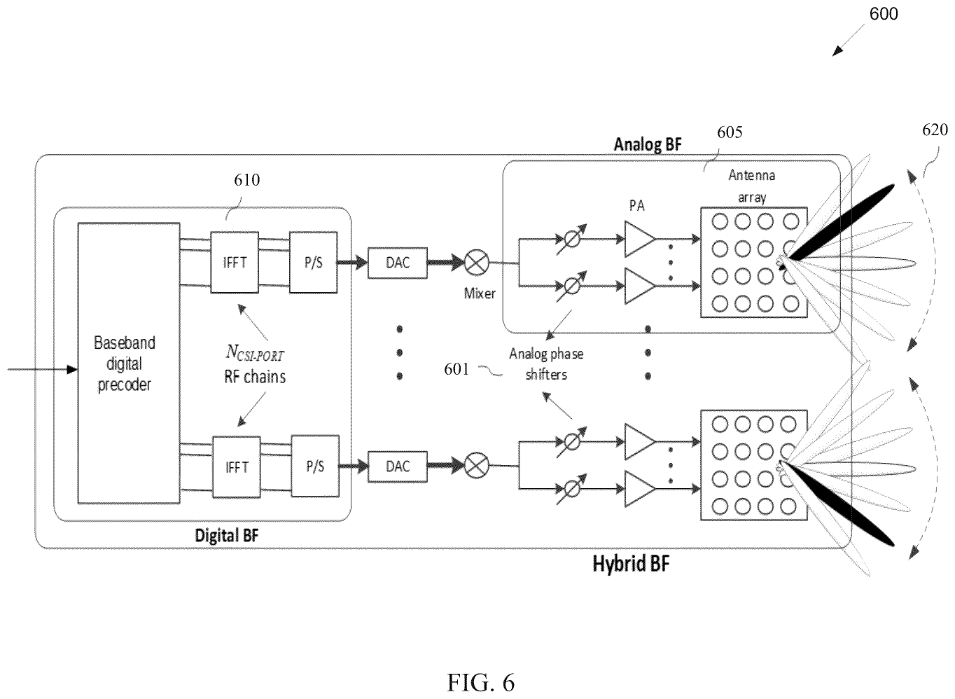

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 6.

FIG. 6 illustrates an example antenna structure 600 according to various embodiments of the present disclosure. An embodiment of the antenna structure 600 shown in FIG. 6 is for illustration only.

MIMO technologies have a key role in boosting system throughput both in NR and LTE and such a role may continue and further expand in the future generations of wireless technologies.

For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

To enable digital precoding, it is important to provide an efficient design of CSI-RS in order to address various operating conditions while maintaining a low overhead for CSI-RS transmissions. For that reason, three types of CSI reporting mechanism corresponding to three types of CSI-RS measurement behavior are supported in Rel. 13 LTE: 1) “CLASS A” CSI reporting that corresponds to non-precoded CSI-RS, 2) “CLASS B” CSI reporting with K=1 CSI-RS resource that corresponds to UE-specific beamformed CSI-RS, and 3) “CLASS B” reporting with K>1 CSI-RS resources that corresponds to cell-specific beamformed CSI-RS. For non-precoded (NP) CSI-RS, a cell-specific one-to-one mapping between CSI-RS port and TXRU is utilized.

Here, different CSI-RS ports have the same wide beam width and direction and hence generally cell-wide coverage. For beamformed CSI-RS, beamforming operation, either cell-specific or UE-specific, is applied on a non-zero-power (NZP) CSI-RS resource consisting of multiple ports. Here, at least at a given time/frequency resources, CSI-RS ports have narrow beam widths, and hence do not provide cell-wide coverage, and (at least from the eNB perspective) at least some CSI-RS port-resource combinations have different beam directions. The basic principle remains same in NR.

In scenarios where a gNB can measure long-term DL channel statistics for a UE through receptions of signals from the UE, such as SRS or DM-RS, UE-specific beamformed CSI-RS can be readily used. This is typically feasible when UL-DL duplex distance is sufficiently small. When that condition does not hold, UE feedback is necessary for the gNB to obtain an estimate of long-term DL channel statistics (or any of its representation thereof). To facilitate such a procedure, a first beamformed CSI-RS transmitted with periodicity T1 (msec) and a second NP CSI-RS transmitted with periodicity T2 (msec), where T1≤T2. This approach is referred to as hybrid CSI-RS. The implementation of hybrid CSI-RS depends on the definition of CSI processes and NZP CSI-RS resources.

One important component of a MIMO transmission scheme is the accurate CSI acquisition at the gNB (or TRP). For MU-MIMO, in particular, availability of accurate CSI is necessary in order to guarantee robust MU performance and avoid interference among transmissions to different UEs. For TDD systems, CSI can be acquired using SRS transmissions from UEs by relying on DL/UL channel reciprocity. For FDD systems, a gNB can acquire CSI by transmitting CSI-RS and obtaining corresponding CSI reports from UEs. A CSI reporting framework can be “implicit” in the form of CQI/PMI/RI, and possibly CRI, as derived from a codebook assuming SU transmission from eNB. Because of the inherent SU assumption while deriving CSI, implicit CSI feedback is inadequate for MU transmissions. For MU-centric operation, a high-resolution Type-II codebook, in addition to low resolution Type-I codebook, can be used.

A serving gNB can configure Type-I and Type-II CSI codebooks to a UE using higher layer signalling to provide a CodebookConfig IE, as described in 3GPP standard specification, that includes the following parameters: (1) codebookType includes type1, type2 and possibly sub-types such as typeI-SinglePanel, typeI-MultiPanel, typeII, and typeII-PortSelection, and corresponding parameters for each type; (2) n1-n2 configures a number of antenna ports in first (n1) and second (n2) dimension and codebook subset restriction for typeI-SinglePanel; (3) ng-n1-n2 configures a number of antenna panels (ng), a number of antenna ports in first (n1) and second (n2) dimension assuming that the antenna structure is identical for the configured number of panels, and a codebook subset restriction for Type I Multi-panel codebook; (4) n1-n2-codebookSubsetRestriction configures a number of antenna ports in first (n1) and second (n2) dimension and a codebook subset restriction for typeII; and (5) CodebookConfig-r17 includes typeI-SinglePanel1-r17 and typeI-SinglePanel2-r17 for type1 to enable configuration of different antenna structures for two TRPs.

The IE RS-ResourceMapping indicates a resource element mapping for a CSI-RS resource in the time and frequency domains. The container of the IE includes elements for configuration of time and frequency domain resources such as by firstOFDMSymbolInTimeDomain, firstOFDMSymbolInTimeDomain2, and frequencyDomainAllocation, the CSI-RS density by density, the number of ports by nrofPorts, and others. The IE CSI-RS-ResourceMapping comprises the NZP-CSI-RS-Resource and ZP-CSI-RS-Resource configurations that are included in the CSI-ResourceConfig. The IE CSI-ResourceConfig defines a group of one or more NZP-CSI-RS-ResourceSet, CSI-IM-ResourceSet and/or CSI-SSB-ResourceSet.

The IE CSI-ReportConfig is used to indicate to a UE parameters for providing a periodic or semi-persistent CSI report via PUCCH transmissions on the cell where CSI-ReportConfig is included, or to indicate parameters for providing a semi-persistent or aperiodic CSI report on a PUSCH as triggered by a DCI that the UE receives. The CSI-ReportConfig is set for certain CSI-ResourceConfigId for channel/interference measurements. The aforementioned CodebookConfig is also part of CSI-ReportConfig.

For aperiodic CSI, both aperiodic CSI reporting and aperiodic CSI-RS transmission are triggered using a “CSI request” field within a DCI format scheduling a PUSCH transmission, such as DCI format 0_1. The “CSI request” field indicates a “trigger state” that points to a certain CSI-ReportConfigId and resourcesForChannel, e.g., NZP-CSI-RS-ResourceSet. The “CSI request” field can have up to 6 bits and can indicate up to 64 “trigger state.” If a UE is configured with more than 64 “trigger state,” a “aperiodic CSI trigger state subselection” MAC CE identifies a subset of trigger state that are indicated by DCI. A CSI-AperiodicTriggerState can include a number of CSI-AssociatedReportConfigInfo, which provides linked CSI-ReportConfigId and resourcesForChannel.

For semi-persistent CSI on PUCCH, the semi-persistent CSI-RS resource is triggered by a “SP CSI-RS/CSI-IM resource set activation/deactivation” MAC CE that includes a SP CSI-RS resource set ID indicating an index of NZP-CSI-RS-ResourceSet containing semi persistent NZP CSI-RS resources indicating the semi persistent NZP CSI-RS resource set, that is to be activated or deactivated. Semi-persistent CSI reporting on PUCCH is triggered using the “SP CSI reporting on PUCCH activation/deactivation” MAC CE. The field Si in the MAC CE indicates the activation/deactivation status of the semi-persistent CSI report configuration within csi-ReportConfigToAddModList. So refers to the report configuration that includes PUCCH resources for semi-persistent CSI reporting in the indicated BWP and has the lowest CSI-ReportConfigId within the list with type set to semiPersistentOnPUCCH, Si refers to the report configuration that includes PUCCH resources for semi-persistent CSI reporting in the indicated BWP and has the second lowest CSI-ReportConfigId, and so on.

For semi-persistent CSI reporting on PUSCH, a CSI report is triggered using a “CSI request” field in a DCI format 0_1 with CRC scrambled by a SP-CSI-RNTI. The operating details are similar to those for an aperiodic CSI report.

For periodic CSI reporting, both reporting and periodic CSI-RS resources are configured and initiated by CSI-ReportConfig.

A UE is semi-statically configured by higher layers to perform periodic CSI reporting on the PUCCH. A UE can be configured by higher layers for multiple periodic CSI reports corresponding to multiple higher layer configured CSI reporting settings, where the associated CSI resource settings are higher layer configured. Periodic CSI reporting on PUCCH formats 2, 3, 4 supports Type I CSI with wideband granularity.

A UE may perform semi-persistent CSI reporting on the PUCCH applied starting from the first slot that is after slot n+3Nₛₗₒₜ^{subframe,μ}, when the UE may transmit a PUCCH with HARQ-ACK information in slot n corresponding to the PDSCH carrying the activation command described in 3GPP standard specification where p is the SCS configuration for the PUCCH. The activation command may contain one or more reporting settings where the associated CSI resource settings are configured. Semi-persistent CSI reporting on the PUCCH supports Type I CSI. Semi-persistent CSI reporting on the PUCCH format 2 supports Type I CSI with wideband frequency granularity. Semipersistent CSI reporting on PUCCH formats 3 or 4 supports Type I CSI with wideband and sub-band frequency granularities and Type II CSI Part 1.

When the PUCCH carry Type I CSI with wideband frequency granularity, the CSI payload carried by the PUCCH format 2 and PUCCH formats 3, or 4 are identical and the same irrespective of RI (if reported), CRI (if reported). A CSI-ReportConfig with codebookType set to “typeI-SinglePanel” and the corresponding CSI-RS resource set for channel measurement configured with two resource groups and N resource pairs can be configured with wideband frequency granularity only with csi-ReportMode set to “Model” and numberOfSingleTRP-CSI-Model set to X=0.

For type I CSI sub-band reporting on PUCCH formats 3, or 4, the payload is split into two parts. The first part contains RI (if reported), CRI (if reported), CQI for the first codeword. The second part contains PMI (if reported), LI (if reported) and contains the CQI for the second codeword (if reported) when RI>4. For a CSI-ReportConfig configured with subband reporting, codebookType set to “typeI-SinglePanel” and the corresponding CSI-RS resource set for channel measurement configured with two resource groups and N resource pairs, Part 1 contains RI(s), CRI(s), CQI(s) for the first codeword and is zero padded to a fixed payload size (if needed). Part 2 contains the CQI(s) for the second codeword (if reported) when RI is larger than 4, LIs (if reported) and PMI(s).

A semi-persistent report carried on the PUCCH formats 3 or 4 supports Type II CSI feedback, but only Part 1 of Type II CSI feedback as illustrated in 3GPP standard specification. Supporting Type II CSI reporting on the PUCCH formats 3 or 4 is a UE capability type2-SP-CSI-Feedback-LongPUCCH. A Type II CSI report (Part 1 only) carried on PUCCH formats 3 or 4 may be calculated independently of any Type II CSI reports carried on the PUSCH as illustrated in 3GPP standard specification.

When the UE is configured with CSI Reporting on PUCCH formats 2, 3 or 4, each PUCCH resource is configured for each candidate UL BWP.

If the UE is in an active semi-persistent CSI reporting configuration on PUCCH and has not received a deactivation command, the CSI reporting takes place when the BWP in which the reporting is configured to take place is the active BWP, otherwise the CSI reporting is suspended.

A UE is not expected to report CSI with a total number of UCI bits and CRC bits larger than 115 bits when configured with PUCCH format 4. For CSI reports transmitted on a PUCCH, if all CSI reports consist of one part, the UE may omit a portion of CSI reports. Omission of CSI is according to the priority order determined from the Prii,csi(y, k, c, s) value as defined in 3GPP standard specification. CSI report is omitted beginning with the lowest priority level until the CSI report code rate is less or equal to the one configured by the higher layer parameter maxCodeRate.

If any of the CSI reports consist of two parts, the UE may omit a portion of Part 2 CSI. Omission of Part 2 CSI is according to the priority order shown in 3GPP standard specification. Part 2 CSI is omitted beginning with the lowest priority level until the Part 2 CSI code rate is less or equal to the one configured by higher layer parameter maxCodeRate.

A UE may perform aperiodic CSI reporting using PUSCH on serving cell upon successful decoding of a DCI format 0_1 or DCI format 0_2 which triggers an aperiodic CSI trigger state.

When a DCI format 0_1 schedules two PUSCH allocations, the aperiodic CSI report is carried on the second scheduled PUSCH. When a DCI format 0_1 schedules more than two PUSCH allocations, the aperiodic CSI report is carried on the penultimate scheduled PUSCH.

An aperiodic CSI report carried on the PUSCH supports wideband, and sub-band frequency granularities. An aperiodic CSI report carried on the PUSCH supports Type I, Type II, enhanced Type II and further enhanced Type II port selection CSI.

A UE may perform semi-persistent CSI reporting on the PUSCH upon successful decoding of a DCI format 0_1 or DCI format 0_2 which activates a semi-persistent CSI trigger state. DCI format 0_1 and DCI format 0_2 contains a CSI request field which indicates the semi-persistent CSI trigger state to activate or deactivate. Semi-persistent CSI reporting on the PUSCH supports Type I, Type II with wideband, and sub-band frequency granularities, enhanced Type II and further enhanced Type II port selection CSI. The PUSCH resources and MCS may be allocated semi-persistently by an uplink DCI.

CSI reporting on PUSCH can be multiplexed with uplink data on PUSCH except that semi-persistent CSI reporting on PUSCH activated by a DCI format is not expected to be multiplexed with uplink data on the PUSCH. CSI reporting on PUSCH can also be performed without any multiplexing with uplink data from the UE.

Type I CSI feedback is supported for CSI reporting on PUSCH. Type I wideband and sub-band CSI is supported for CSI reporting on the PUSCH. Type II CSI is supported for CSI reporting on the PUSCH.

For Type I, Type II, enhanced Type II and further enhanced Type II port selection CSI feedback on PUSCH, a CSI report comprises of two parts. Part 1 has a fixed payload size and is used to identify the number of information bits in Part 2. Part 1 may be transmitted in its entirety before Part 2.

For Type I CSI feedback, Part 1 contains RI (if reported), CRI (if reported), CQI for the first codeword (if reported). Part 2 contains PMI (if reported), LI (if reported) and contains the CQI for the second codeword (if reported) when RI is larger than 4. For a CSI-ReportConfig configured with codebookType set to “typeISinglePanel” and the corresponding CSI-RS resource set for channel measurement configured with two resource groups and N resource pairs, Part 1 contains RI(s), CRI(s), CQI(s) for the first codeword and is zero padded to a fixed payload size (if needed). Part 2 contains the CQI(s) for the second codeword (if reported) when RI is larger than 4, Us (if reported) and PMI(s).

For Type II CSI feedback, Part 1 contains RI (if reported), CQI, and an indication of the number of non-zero wideband amplitude coefficients per layer for the Type II CSI as illustrated in 3GPP standard specification. The fields of Part 1—RI (if reported), CQI, and the indication of the number of non-zero wideband amplitude coefficients for each layer—are separately encoded. Part 2 contains the PMI and LI (if reported) of the Type II CSI. The elements of i_{1,4,l}, i_{2,1,l} (if reported) and i_{2,2,l} (if reported) are reported in the increasing order of their indices, i=0,1, . . . , 2L−1, where the element of the lowest index is mapped to the most significant bits and the element of the highest index is mapped to the least significant bits. Part 1 and 2 are separately encoded.

For enhanced Type II CSI feedback as illustrated in 3GPP standard specification and further enhanced Type II port selection CSI feedback as illustrated in 3GPP standard specification, Part 1 contains RI (if reported), CQI, and an indication of the overall number of non-zero amplitude coefficients across layers. The fields of Part 1—RI (if reported), CQI, and the indication of the overall number of non-zero amplitude coefficients across layers—are separately encoded. Part 2 contains the PMI of the enhanced Type II or further enhanced Type II port selection CSI. Part 1 and 2 are separately encoded.

A Type II CSI report that is carried on the PUSCH may be computed independently from any Type II CSI report that is carried on the PUCCH formats 3 or 4 as illustrated in 3GPP standard specification.

When the higher layer parameter reportQuantity is configured with one of the values “cri-RSRP,” “ssb-Index-RSRP,” “criSINR” or “ssb-Index-SINR,” or “cri-RSRP-Capability[Set] Index,” “ssb-Index-RSRP-Capability[Set] Index,” “cri-SINRCapability[Set] Index,” “ssb-Index-SINR-Capability[Set] Index,” the CSI feedback consists of a single part.

For both Type I and Type II reports configured for PUCCH but transmitted on PUSCH, the determination of the payload for CSI part 1 and CSI part 2 follows that of PUCCH as described in 3GPP standard specification.

When CSI reporting on PUSCH comprises two parts, the UE may omit a portion of the Part 2 CSI. Omission of Part 2 CSI is according to the priority order shown in 3GPP standard specification, where N_{Rep} is the number of CSI reports configured to be carried on the PUSCH. Priority 0 is the highest priority and priority 2N_{Rep} is the lowest priority and the CSI report n corresponds to the CSI report with the nth smallest Prii,csi(y, k, c, s) value among the N_{Rep} CSI reports as defined in 3GPP standard specification.

The subbands for a given CSI report n indicated by the higher layer parameter csi-ReportingBand are numbered continuously in increasing order with the lowest subband of csi-ReportingBand as subband 0. When omitting Part 2 CSI information for a particular priority level, the UE may omit all of the information at that priority level.

The CSI reference resource for a serving cell is defined as shown in TABLE 1.

TABLE 1
CSI reference resources

In the frequency domain, the CSI reference resource is defined by the group of downlink
physical resource blocks corresponding to the band to which the derived CSI relates.
In the time domain, the CSI reference resource for a CSI reporting in uplink slot n′ is
$defined by a single downlink slot n - {n}_{CSI \_ ref} - {K}_{offset} \cdot \frac{{2}^{{μ}_{DL}}}{{2}^{{μ}_{{K}_{offset}}}} , where {K}_{offset} is a$
parameter configured by higher layer as specified in 3GPP standard specification, and where
μ_{K}_{_{offset}} is the subcarrier spacing configuration for K_{offset} with a value of 0 for frequency range
1,
$where n = ⌊ {n}^{′} \cdot \frac{{2}^{{μ}_{DL}}}{{2}^{{μ}_{UL}}} ⌋ + ⌊ ( \frac{{N}_{slot , offset , UL}^{CA}}{{2}^{{μ}_{offset , UL}}} - \frac{{N}_{slot , offset , DL}^{CA}}{{2}^{{μ}_{offset , DL}}} ) \cdot {2}^{{μ}_{DL}} ⌋ and {μ}_{DL} and {μ}_{DL} are the$
subcarrier spacing configurations for DL and UL, respectively, and N_{slot,offset}^{CA} and μ_{offset} are
determined by higher-layer configured ca-SlotOffset for the cells transmitting the uplink and
downlink, as defined in 3GPP standard specification.
where for periodic and semi-persistent CSI reporting
if a single CSI-RS/SSB resource is configured for channel measurement n_{CSI}_ref is the
smallest value greater than or equal to 4 · 2^{μ}^{_{DL}}, such that it corresponds to a valid downlink slot,
or
if multiple CSI-RS/SSB resources are configured for channel measurement n_{CSI}_ref is the
smallest value greater than or equal to 5 · 2^{μ}^{_{DL}}, such that it corresponds to a valid downlink slot.
where for aperiodic CSI reporting, if the UE is indicated by the DCI to report CSI in the
same slot as the CSI request, n_{CSI-ref} is such that the reference resource is in the same valid
downlink slot as the corresponding CSI request, otherwise n_{CSI}_ref is the smallest value greater
than or equal to └Z′/N_{symb}^{slot}┘, such that slot n-n_{CSI}_ref corresponds to a valid downlink slot,
where Z′ corresponds to the delay requirement as defined in 3GPP standard specification.
when periodic or semi-persistent CSI-RS/CSI-IM or SSB is used for
channel/interference measurements, the UE is not expected to measure channel/interference on
the CSI-RS/CSI-IM/SSB whose last OFDM symbol is received up to Z′ symbols before
transmission time of the first OFDM symbol of the aperiodic CSI reporting.

When the CSI request field on a DCI triggers a CSI report(s) on PUSCH, the UE may provide a valid CSI report for the n-th triggered report as shown in TABLE 2.

TABLE 2

CSI report for the triggered report
if the first uplink symbol to carry the corresponding
CSI report(s) including the effect of the timing
advance, starts no earlier than at symbol Z_{ref}, and
if the first uplink symbol to carry the n-th CSI
report including the effect of the timing
advance, starts no earlier than at symbol Z′_{ref}(n),
where Z_{ref} is defined as the next uplink symbol
with its CP starting T_{proc,CSI} = (Z)(2048 +
144) · κ2^{-μ} · T_{C} + T_{switch} after the end of the last
symbol of the PDCCH triggering the CSI
report(s), and where Z′_{ref}(n), is defined as the next
uplink symbol with its CP starting T′_{proc,CSI} =
(Z′)(2048 + 144) · κ2^{-μ} · T_{C} after the end of the
last symbol in time of the latest of: aperiodic
CSI-RS resource for channel measurements,
aperiodic CSI-IM used for interference
measurements, and aperiodic NZP CSI-RS for
interference measurement, when aperiodic CSI-
RS is used for channel measurement for the n-th
triggered CSI report, and where T_{switch} is defined
in 3GPP standard specification and is applied only
if Z₁ as shown in 3GPP standard specification
is applied.

If the PUSCH indicated by the DCI is overlapping with another PUCCH or PUSCH, then the CSI report(s) are multiplexed following the procedure in 3GPP standard specification when applicable, otherwise the CSI report(s) are transmitted on the PUSCH indicated by the DCI.

When the CSI request field on a DCI triggers a CSI report(s) on PUSCH, if the first uplink symbol to carry the corresponding CSI report(s) including the effect of the timing advance, starts earlier than at symbol Z_{ref}: the UE may ignore the scheduling DCI if no HARQ-ACK or transport block is multiplexed on the PUSCH.

When the CSI request field on a DCI triggers a CSI report(s) on PUSCH, if the first uplink symbol to carry the n-th CSI report including the effect of the timing advance, starts earlier than at symbol Z′_{ref}(n): the UE may ignore the scheduling DCI if the number of triggered reports is one and no HARQ-ACK or transport block is multiplexed on the PUSCH; otherwise, the UE is not required to update the CSI for the n-th triggered CSI report.

When the PDCCH reception includes two PDCCH candidates from two respective search space sets, as described in 3GPP standard specification, for the purpose of determining the last symbol of the PDCCH triggering the CSI report(s), the PDCCH candidate that ends later in time is used.

Z, Z′ and μ are defined as shown in TABLE 3.

TABLE 3
Definition of Z, Z′ and μ

$Z = {max}_{m = 0 , … , M - 1} ( Z ( m ) ) and {Z}^{′} = {max}_{m = 0 , … , M - 1} ( {Z}^{′} ( m ) ) , where M is the number of update CSI$
report(s) according to Clause 5.2.1.6, (Z(m), Z′(m)) corresponds to the m-th updated CSI
report and is defined as
(Z₁, Z₁′) as illustrated in 3GPP standard specification, if max{μ_{PDCCH}, μ_{CSI-RS}, μ_{UL}} ≤ 3
and if the CSI is triggered without a PUSCH with either transport block or HARQ-ACK or both
when L = 0 CPUs are occupied (according to 3GPP standard specification) and the CSI to be
transmitted is a single CSI and corresponds to wideband frequency-granularity where the CSI
corresponds to at most 4 CSI-RS ports in a single resource without CRI report and where
CodebookType is set to “typeI-SinglePanel” or where reportQuantity is set to “cri-RI-CQI,” or
(Z₁, Z₁′) as illustrated in 3GPP standard specification, if the CSI to be transmitted
corresponds to wideband frequency-granularity where the CSI corresponds to at most 4 CSI-RS
ports in a single resource without CRI report and where CodebookType is set to “typeI-
SinglePanel” or where reportQuantity is set to “cri-RI-CQI,” or
(Z₁, Z₁′) as illustrated in 3GPP standard specification, if the CSI to be transmitted
corresponds to wideband frequency-granularity where the reportQuantity is set to “ssb-Index-
SINR,” “cri-SINR,” “ssb-Index-SINR-Capability[Set]Index,” or “cri-SINR-
Capability[Set]Index,” or
(Z₃, Z₃′) as illustrated in 3GPP standard specification, if reportQuantity is set to “cri-
RSRP,” “ssb-Index-RSRP,” “cri-RSRP-Capability[Set]Index” or “ssb-Index-RSRP-
Capability[Set]Index,” where Xμ is according to UE reported capability beamReportTiming
and KBₗ is according to UE reported capability beamSwitchTiming as defined in 3GPP standard
specification, or
(Z₂, Z₂′) as illustrated in 3GPP standard specification, otherwise.
μ as illustrated in 3GPP standard specification corresponds to the min (μ_{PDCCH}, μ_{CSI-RS},
μ_{UL}) where the μ_{PDCCH} corresponds to the subcarrier spacing of the PDCCH with which the
DCI was transmitted and μ_{UL} corresponds to the subcarrier spacing of the PUSCH with which
the CSI report is to be transmitted and μ_{CSI-RS} corresponds to the minimum subcarrier spacing
of the aperiodic CSI-RS triggered by the DCI.

Present networks have limited capability to adapt an operation state in one or more of time/frequency/spatial/power domains. For example, in NR, there are transmissions or receptions by a serving gNB that are always expected by UEs, such as transmissions of synchronization signal/physical broadcast channel (SS/PBCH) blocks, or of system information, or of CSI-RS indicated by higher layers, or receptions of physical random access channel (PRACH) or sounding reference signal (SRS) indicated by higher layers. Reconfiguration of a NW operation state involves higher layer signaling by a system information block (SIB) or by UE-specific RRC. That is a slow process and requires substantial signaling overhead, particularly for UE-specific RRC signaling.

For example, it is currently not practical or possible for a network in typical deployments to enter an energy saving state where the network does not transmit or receive due to low traffic as, in order to obtain material energy savings, the network needs to suspend transmissions or receptions for several tens of milliseconds and preferably for even longer time periods. A similar inability exists for suspending transmission or receptions for shorter time periods as a serving gNB may need to frequently transmit SS/PBCH blocks, such as every 5 msec or every 20 msec and, in time division duplex (TDD) systems with UL-DL configurations having few UL symbols in a period, the serving gNB may need to receive PRACH or SRS in most UL symbols in a period.

Due to the above reasons, adaptation of a NW operation state is typically over long time periods, such as for off-peak hours when an amount of served traffic is small and for peak hours when an amount of served traffic is large. Therefore, a capability of a gNB to improve service by fast adaptation of a NW operation state to the traffic types and load, or to save energy by switching to a state that requires less energy consumption when an impact on service quality may be limited or none, is currently limited as there are no procedures for a serving gNB to perform fast adaptation of a NW operation state with small signaling overhead while simultaneously informing all UEs of the NW operation state.

It is also beneficial to support a gradual transition of NW operation states between a maximum state where the NW operates at its maximum capability in one or more of a time/frequency/spatial/power domain and a minimum state where the NW operates at its minimum capability or the NW enters a sleep mode. That may allow continuation of service while the NW transitions from a state with larger utilization of time/frequency/spatial/power resources to a state with lower utilization of such resources and the reverse as UEs can obtain time/frequency synchronization and AGC alignments, perform measurements and provide CSI reports or transmit SRS prior to scheduling of PDSCH receptions or PUSCH transmissions.

In order to enable a gNB to sleep and save energy while minimizing an impact on served UEs, the gNB can apply discontinued transmissions (e.g., cell DTX) or discontinued receptions (cell DRX) on a serving cell. UEs in the cell can be informed of corresponding cell DTX/DRX configurations such that the UEs can operate accordingly and avoid power consumption when the serving gNB is in dormancy (cell DTX/DRX). By turning off all or a part of a transmission chain and pausing transmission during the cell DTX, the gNB can reduce energy consumption for standby when there is little to no traffic.

For cell DTX, a UE may assume that all transmissions from a serving gNB are suspended or the UEs may assume that some signals, such as PSS or SSS for maintaining synchronization, remain present during cell DTX. By turning off all or a part of receiver chain and pausing receptions during the cell DRX, the gNB can reduce energy consumption for standby when there is little to no traffic. For cell DRX, a UE may assume that all transmissions from the UE are suspended or may assume that some transmissions, such as ones required for initial access such as PRACH, are allowed during a cell DRX duration.

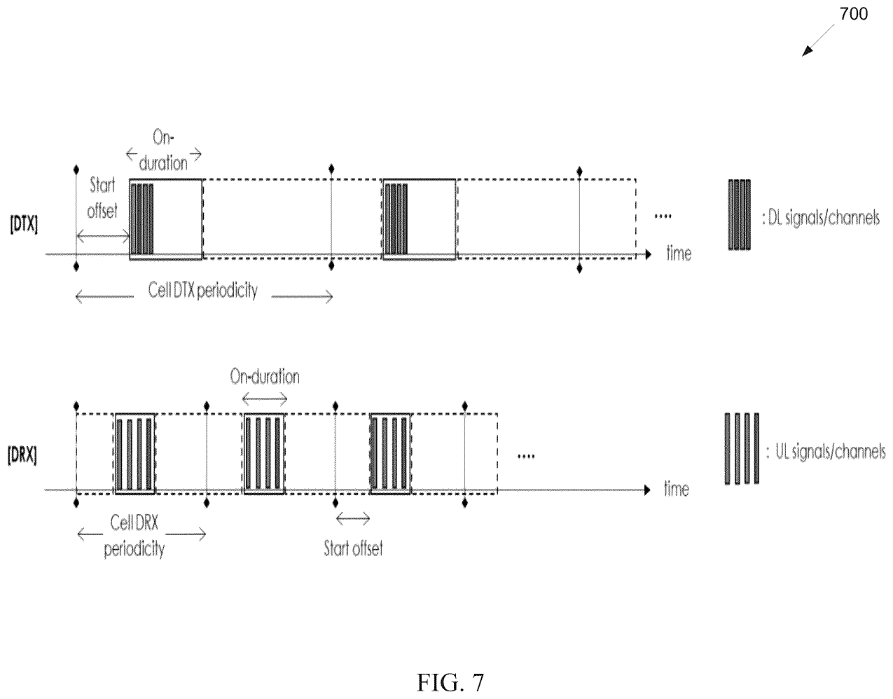

FIG. 7 illustrates an example of a cell DTX/DRX 700 according to various embodiments of the present disclosure. An embodiment of the cell DTX/DRX 700 shown in FIG. 7 is for illustration only.

As illustrated in FIG. 7, cell DTX/DRX can be configured via at least a periodicity, a start slot/offset, and an on-duration. A UE assumes that all transmissions/receptions by the gNB are enabled during the DTX/DRX on-duration, respectively. The configurations and operations of cell DTX and cell DRX can be linked or can be separate, for example depending on DL/UL traffic characteristics.

The energy consumption by power amplifiers (PA) for each set of antenna elements (AEs) accounts for a large portion of total energy consumption by a gNB equipped with massive MIMO antennas. For network energy savings, when the traffic load is low, the gNB can turn off a subset of PAs or reduce the PA output power levels. For brevity, such operation is respectively referred to as spatial domain (SD) or power domain (PD) adaptation in this embodiment of the disclosure. Unlike cell DTX/DRX illustrated in FIG. 7, one advantage of SD/PD adaptation is that the network can maintain continuity of transmissions and receptions without interruptions by operating at a reduced capability.

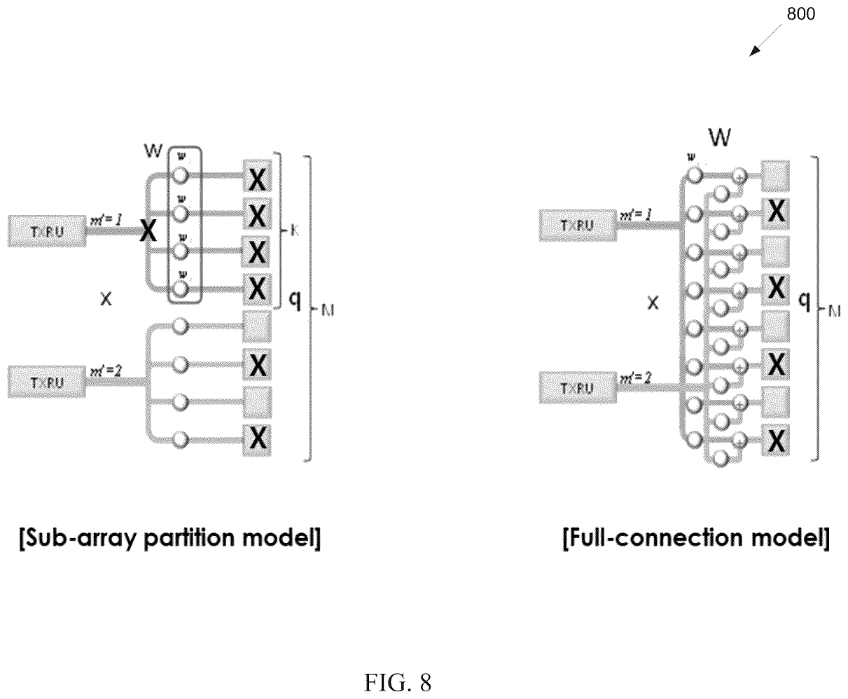

FIG. 8 illustrates an example of spatial element adaptation 800 according to various embodiments of the present disclosure. An embodiment of the spatial element adaptation 800 shown in FIG. 8 is for illustration only.

A gNB can enable/disable all AEs associated to a logical antenna port or enable/disable a subset of AEs associated to a logical antenna port. For brevity, those adaptations of AEs are respectively referred to as Type 1 and Type 2 SD adaptations in this embodiment of the disclosure. The gNB may perform Type 1 SD adaptation, or Type 2 SD adaptation, or both.

In a hybrid beamforming system as illustrated in FIG. 6, one antenna port is connected to a large number of AEs that can be controlled by a bank of analog phase shifters, which is referred to as TxRU virtualization. The TxRU virtualization can be implemented based on sub-array partition model, full-connection model, or combinations of them, as illustrated in FIG. 8.

In a sub-array partition model, spatial element adaptations can result in both Type 1 and Type 2 SD adaptations. In case of Type 1 SD adaptation, both the PAs connected to AEs associated to a logical antenna port and the subsequent RF chain, e.g., ADC/DAC, etc., associated to the logical antenna port can be turned off. In a full-connection model, spatial element adaptations can only result in Type 2 SD adaptations unless all the antenna ports are turned off.

The impact of Type 1 SD adaptation results in a change in the number of active antenna ports or antenna structure in general. The RF characteristics, e.g., radiation power, beam pattern, etc., of remaining antenna ports remain same. The impact of Type 2 SD adaptation results in a change in the RF characteristics of antenna ports affected by AE on/off while the number of antenna ports remains the same. The impact of PD adaptation is similar to Type 2 SD adaptation. A gNB can perform any combination of Type 1 SD, Type 2 SD, and PD adaptations together with other time/frequency domain adaptation techniques such as cell DTX/DRX.

Network operation parameters for transmission or reception can be in one or more of a power, spatial, time, or frequency domain.

For example, in power domain, a first NW operation state can be associated with a first value of parameter ss-PBCH-BlockPower providing an average energy per resource element (EPRE) with secondary synchronization signals (SSS) in dBm, and a second NW operation state can be associated with a second value of a parameter ss-PBCH-BlockPower. For example, first and second NW operation states can be respectively associated with first and second values of parameter powerControlOffsetSS that provides a power offset (in dB) of non-zero power (NZP) CSI-RS RE to SSS RE. For example, first and second NW operation states can be respectively associated with first and second values of parameter powerControlOffset that provides a power offset (in dB) of PDSCH RE to NZP CSI-RS RE.

For example, in frequency domain, first and second NW operation states can be respectively associated with first and second values of a parameter locationAndBandwidth that indicates a frequency domain location and a bandwidth for receptions or transmissions by UEs. For example, first and second NW operation states can be respectively associated with first and second values of a parameter BWP-Id for DL and UL. For example, first and second NW operation states can be respectively associated with first and second values of a list of serving cells for active transmission and reception.

For example, in spatial domain, first and second NW operation states can be respectively associated with first and second values of a parameter maxMIMO-Layers that indicates a maximum number of MIMO layers to be used for PDSCH receptions by a UE in the associated active DL BWP, or with first and second values of a parameter nrOfAntennaPorts that indicates a number of antenna ports to be used for codebook determination for PDSCH receptions, or with first and second values of a parameter activeCoresetPoolIndex that coresetPoolIndex values for PDCCH transmissions in corresponding CORESETs and UEs can skip PDCCH receptions in a CORESET with coresetPoolIndex value that is not indicated by activeCoresetPoolIndex.

For example, first and second NW operation states can be respectively associated with first and second values of an antenna port subset that indicates a list of active antenna ports for CSI calculation and other associated parameters such as codebook subset restriction, rank restriction, the logical antenna size in two-dimension, number of antenna ports, and a list of CSI-RS resources, etc.

For example, in time domain, first and second NW operation states can be respectively associated with first and second values of a parameter ssb-PeriodicityServingCell that indicates a transmission periodicity in milliseconds for SS/PBCH blocks, or with first and second values of a parameter ssb-PositionsInBurst that indicates time domain positions of SS/PBCH blocks in a SS/PBCH block transmission burst, or with first and second values of a parameter groupPresence that indicates groups of SS/PBCH blocks, such as groups of four SS/PBCH blocks with consecutive indexes, that are transmitted. For example, first and second NW operation states can be respectively associated with first and second values of a time pattern, e.g., in terms of periodicity, on-duration, start offset, etc., that indicates cell discontinuous transmission (DTX) or cell discontinuous reception (DRX).

A network may need to assess an impact of adapting network transmission or reception parameters in one or more of a power, spatial, time, or frequency domain prior to executing an actual adaptation by providing multiple CSI report sub-configurations, which correspond to different network adaptation hypotheses, and receiving multiple CSI reports from the UE. For CSI reporting with sub-configurations, there is a need for defining procedures and methods to determine a CSI reference resource for one or more sub-configurations for different types of CSI reporting and to determine omission of CSI reports corresponding to sub-configurations not having a valid downlink CSI reference resource, which may be impacted by cell DTX/DRX off-durations such as CSI-RS and CSI-IM occasions are not valid during cell DTX off-durations.

When a UE is signaled on the activation of cell DTX/DRX, if the UE receives at least one CSI-RS transmission occasion for channel measurement and CSI-RS and/or CSI-IM occasion for interference measurement during cell DTX on-duration no later than CSI reference resource, there is a need for defining procedures and methods to determine the transmission of a CSI report, if the uplink slot for transmitting the CSI report falls in a cell DRX off-duration. Otherwise, i.e., if the UE does not receive at least one CSI-RS transmission occasion for channel measurement and CSI-RS and/or CSI-IM occasion for interference measurement during cell DTX on-duration no later than CSI reference resource per CSI sub-configuration, the CSI report is not transmitted.

For CSI reporting with sub-configurations, there is a need for defining procedures and methods to determine CSI processing unit (CPU) occupation time and antenna port counting.

For CSI reporting with sub-configurations, the UE may be signaled to use a common CRI for CSI reporting across a number of sub-configurations triggered for CSI reporting. For CSI reporting based on a common CRI, there is a need for defining procedures and methods to determine a CSI reference resource for one or more sub-configurations for different types of CSI reporting and to determine omission of CSI reports corresponding to sub-configurations not having a valid downlink CSI reference resource.

The present disclosure relates to a communication system. The present disclosure relates to defining functionalities and procedures for reporting CSI that is associated with multiple network operating states (adaptation hypotheses) in one or more of a power, spatial, time, or frequency domain, for example in order to support network energy savings.

The present disclosure further relates to determining CSI reference resource for a CSI report with sub-configuration(s).

The present disclosure also relates to determining a transmission of a CSI report during cell DRX off-durations.

The present disclosure is further related to determining CSI Processing Unit occupation time and antenna port counting for a CSI report with sub-configuration(s).

The present disclosure is additionally related to common CRI reporting for a CSI report with sub-configuration(s).

Embodiments of the present disclosure for reporting CSI associated with multiple network operating states (adaptation hypotheses) in one or more of a power, spatial, time, or frequency domain, for example in order to support network energy savings, are summarized in the following and are fully elaborated further below: (1) method and apparatus for determining CSI reference resource for a CSI report with sub-configuration(s), which is impacted by cell DTX/DRX; (2) method and apparatus for determining a transmission of a CSI report during cell DRX off-durations; (3) method and apparatus for determining CSI processing unit occupation time and antenna port counting for a CSI report with sub-configuration(s); and (4) method and apparatus for common CRI reporting for a CSI report with sub-configuration(s).

A serving gNB can indicate to a UE a number of hypotheses on transmission/reception parameters and the UE can provide to the serving gNB a number of CSI reports according to the indicated hypotheses that correspond to possible network operating states. For a CSI report, a number of sub-configurations associated with network operating states (adaptation hypotheses) can be provided by the serving gNB to the UE. Each sub-configuration describes a hypothesis on the network operation parameters for transmission or reception in one or more of a power, a spatial, a time, or a frequency domain.

The gNB can indicate the UE to perform CSI measurement and reporting according to indicated CSI report sub-configurations. Triggering of CSI reporting can be via DCI in a PDCCH reception, or via MAC CE or RRC IE in a PDSCH reception. The signaling can be UE-specific (such as by DCI/TB with CRC scrambled by C-RNTI or DCI/TB associated with a PDCCH reception in CCEs determined according to a UE-specific search space), UE-group-specific (such as by DCI/TB with CRC that is not scrambled by C-RNTI or DCI/TB associated with a PDCCH reception in CCEs determined according to a common search space), or cell-specific for example via a SIB.

For example, a UE can monitor PDCCH for detecting a DCI format that triggers multiple CSI reports, which correspond to a number of CSI report sub-configurations provided in the CSI report configuration, according to a CSS set or a USS set. A list of CSI report sub-configuration indexes for reporting can be indicated in the DCI or by higher layer signaling, such as in a RRC IE or a MAC CE update, as a part of a “trigger state” that is indicated by the DCI among a set of “trigger states.” In another example, CSI is reported for entire list of CSI report sub-configurations such as for a periodic CSI report.

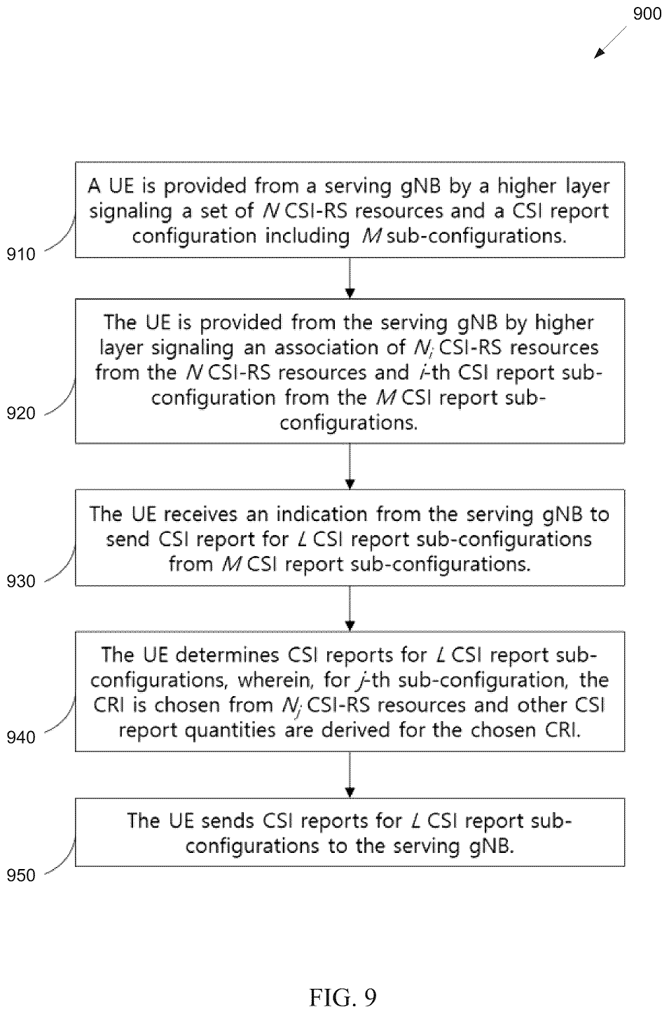

FIG. 9 illustrates a flowchart of a UE method 900 for sending multiple CSI reports according to various embodiments of the present disclosure. The UE method 900 as may be performed by a UE (e.g., 111-116 as illustrated in FIG. 1). An embodiment of the UE method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

As illustrated in FIG. 9, a UE is provided from a serving gNB by higher layer signaling a set of N CSI-RS resources and a CSI report configuration including M sub-configurations in step 910. The higher layer signaling can be an RRC IE. The set of N CSI-RS resources and the CSI report configuration including M sub-configurations may also be updated by a MAC CE that indicates corresponding subsets of the ones provided in the RRC IE.

The UE is provided from the serving gNB by higher layers an association of Nᵢ CSI-RS resources from the N CSI-RS resources with i-th CSI report sub-configuration from the M CSI report sub-configurations in step 920.

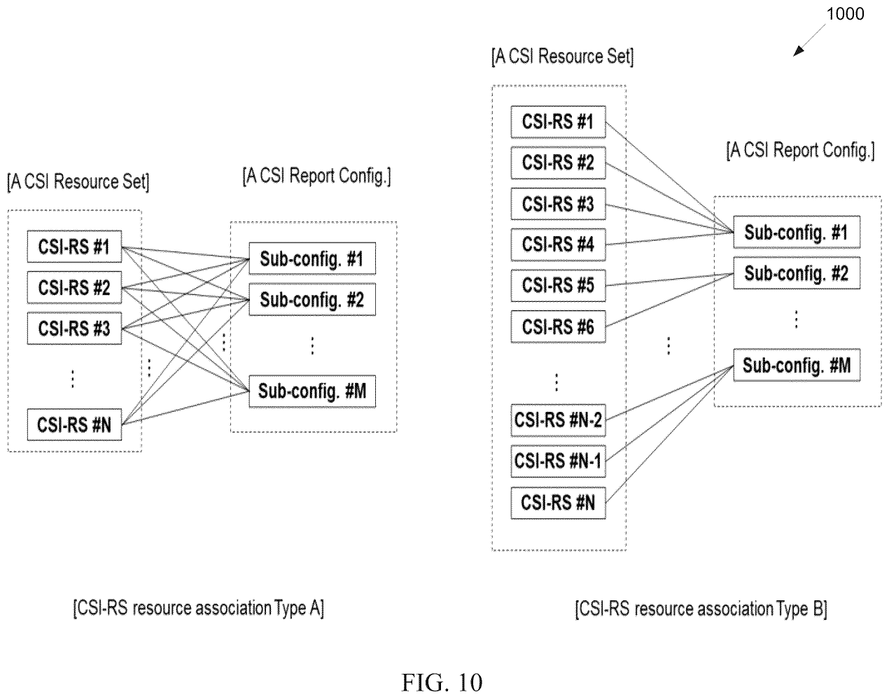

FIG. 10 illustrates an example of association of CSI-RS resources with CSI report sub-configurations 1000 according to various embodiments of the present disclosure. An embodiment of the association of CSI-RS resources with CSI report sub-configurations 1000 shown in FIG. 10 is for illustration only.

In one example, a CSI-RS resource within a CSI-RS resource set can be associated with more than one CSI report sub-configurations. In another example, a CSI-RS resource can be associated with only one CSI report sub-configuration. In the former case, a CSI-RS resource is associated with multiple different network operating states (adaptation hypotheses), while in the latter case, a CSI-RS resource is associated with only one network operating state (adaptation hypothesis). A number of CSI-RS resources associated with each CSI report sub-configuration can be separately indicated and may be same or different. In FIG. 10, Nᵢ=N, ∀i∈{1, . . . , M} for the example on the left-hand side, i.e., all the CSI-RS resources are associated with all the sub-configurations and, therefore, the set of CSI-RS resources are identical for all the sub-configurations. In FIG. 10, Σᵢ^{M}Nᵢ=N for the example on the right-hand side, i.e., the set of CSI-RS resources for each sub-configuration does not intersect with each other. In yet another example, a CSI-RS resource can be associated with one or more CSI report sub-configurations.

The UE receives an indication from the serving gNB to provide a CSI report for L CSI report sub-configurations from M CSI report sub-configurations in step 930. The indication can be explicit for aperiodic and semi-persistent CSI report, and it is implicit for periodic CSI report such that L=M.

The UE determines CSI reports for L CSI report sub-configurations, wherein, for j-th sub-configuration, a CRI is selected from Nⱼ CSI-RS resources and other CSI report quantities are derived for the CRI in step 940.

If the UE is provided a common set of CSI-RS resources for all the M CSI report sub-configurations or for L triggered CSI report sub-configurations, the UE may report a single CRI that is common across multiple CSI reports. In one example, the UE selects the single CRI based on the CSI report for the first sub-configuration. In this example, the CPU occupancy can be counted as O_{CPU}=N₁ₛₜ+L−1, where N₁ₛₜ is the number of CSI-RS resources associated with the first sub-configuration, which may be same for other sub-configurations. In another example, the UE selects the single CRI based on all CSI reports for L sub-configurations. In this example, the CPU occupancy can be counted as O_{CPU}=Σ_{j∈L}Nⱼ. Other CSI report quantities are calculated for the selected single CRI. Therefore, in this example, the UE reports a single CRI and a set of L other CSI report quantities for L CSI report sub-configurations.

The UE provides the CSI reports for the L CSI report sub-configurations to the serving gNB in step 950, for example in a PUCCH or in a PUSCH.

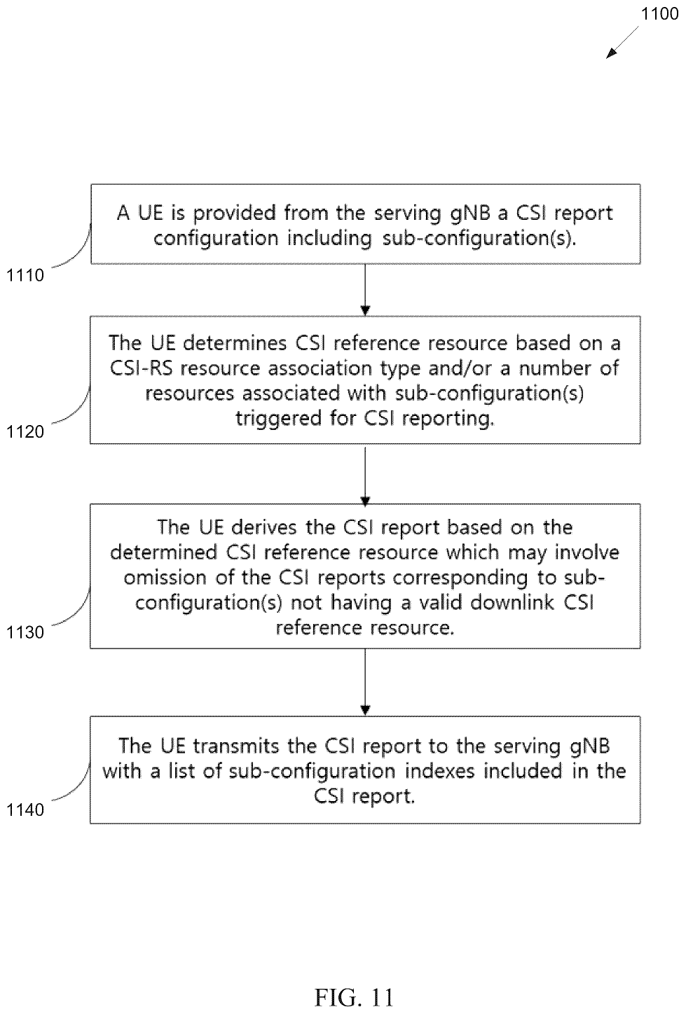

FIG. 11 illustrates a flowchart of a UE method 1100 for determining CSI reference resource and CSI according to various embodiments of the present disclosure. The UE method 1100 as may be performed by a UE (e.g., 111-116 as illustrated in FIG. 1). An embodiment of the UE method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

A UE is provided from the serving gNB a CSI report configuration including sub-configuration(s) in step 1110. The UE determines CSI reference resource based on a CSI-RS resource association type and/or a number of resources associated with sub-configuration(s) triggered for CSI reporting in step 1120. The UE derives the CSI report based on the determined CSI reference resource which may involve omission of the CSI reports corresponding to sub-configuration(s) not having a valid downlink CSI reference resource in step 1130, which may be due to cell DTX off-durations. The UE transmits the CSI report to the serving gNB with a list of sub-configuration indexes included in the CSI report in step 1140.

For periodic and semi-persistent CSI reporting with sub-configuration(s) and for CSI-RS resource association Type A wherein all the CSI-RS resources in a resource set are associated with all the sub-configurations of a CSI report, if a single CSI-RS resource is configured for channel measurement in a resource set, the CSI reference resource for a CSI reporting in uplink slot n′, n_{CSI_ref}, in 3GPP standard specification is the smallest value greater than or equal to 4·2^{μ}^{_{DL}}, such that it corresponds to a valid downlink slot, or, if multiple CSI-RS resources are configured for channel measurement in a resource set, n_{CSI_ref} is the smallest value greater than or equal to 5·2^{μ}^{_{DL}}, such that it corresponds to a valid downlink slot. Type-1 SD adaptation and PD adaptation are subject to CSI-RS resource association Type A.

For periodic and semi-persistent CSI reporting with sub-configuration(s) and for CSI-RS resource association Type B wherein different subsets of CSI-RS resources in a resource set can be associated with different sub-configurations of a CSI report, if all the M sub-configurations provided to a UE are associated with a single CSI-RS resource for channel measurement, the CSI reference resource for a CSI reporting, n_{CSI_ref}, is the smallest value greater than or equal to 4·2^{μ}^{_{DL}}, such that it corresponds to a valid downlink slot.

Alternatively, if L sub-configurations triggered for CSI reporting from M sub-configurations provided to a UE are associated with a single CSI-RS resource for channel measurement, the CSI reference resource for a CSI reporting, n_{CSI_ref}, is the smallest value greater than or equal to 4·2^{μ}^{_{DL}}, such that it corresponds to a valid downlink slot. The M−L sub-configurations not triggered for CSI reporting may be associated with one or more CSI-RS resources for channel measurement. If any of the M sub-configurations provided to a UE are associated with multiple CSI-RS resources for channel measurement, the CSI reference resource for a CSI reporting, n_{CSI_ref}, is the smallest value greater than or equal to 5-2^{DL}, such that it corresponds to a valid downlink slot.

Alternatively, if any of the L sub-configurations triggered for CSI reporting from M sub-configurations provided to a UE are associated with multiple CSI-RS resources for channel measurement, the CSI reference resource for a CSI reporting, n_{CSI_ref}, is the smallest value greater than or equal to 5·2^{μ}^{_{DL}}, such that it corresponds to a valid downlink slot. For a periodic CSI reporting, the number of sub-configurations triggered for CSI reporting may be identical to the number of sub-configurations provided to the UE, i.e., L=M. Type-2 SD adaptation is subject to CSI-RS resource association Type B.

For aperiodic CSI reporting, if the UE is indicated by the DCI to report CSI in the same slot as the CSI request, n_{CSI_ref}, is such that the reference resource is in the same valid downlink slot as the corresponding CSI request, otherwise n_{CSI_ref} is the smallest value greater than or equal to └Z′/N_{symb}^{slot}┘, such that slot it corresponds to a valid downlink slot. If aperiodic CSI reporting is associated with a single sub-configuration, the value Z′ corresponds to the delay requirement as defined in 3GPP standard specification, e.g., CSI computation delay requirement 2 in 3GPP standard specification. If aperiodic CSI reporting is associated with multiple sub-configurations, Z′ corresponds to Z₁′, if all the M sub-configurations provided to a UE satisfy the conditions to use Z₁′ as described in 3GPP standard specification.

Alternatively, Z′ corresponds to Z₁′, if all the L sub-configurations triggered for CSI reporting from M sub-configurations provided to the UE satisfy the conditions to use Z₁′ as described in 3GPP standard specification. If aperiodic CSI reporting is associated with multiple sub-configurations, Z′ corresponds to Z₂′, if any of the M sub-configurations provided to a UE does not satisfy the conditions to use Z₁′ as described in 3GPP standard specification. Alternatively, Z′ corresponds to Z₂′, if any of the L sub-configurations triggered for CSI reporting from M sub-configurations provided to the UE does not satisfy the conditions to use Z₁′ as described in 3GPP standard specification.

For any CSI reporting, if there is no valid downlink slot for the CSI reference resource corresponding to a CSI report setting in a serving cell, e.g., due to cell DTX off-durations, for all the M sub-configurations provided to a UE or L sub-configurations triggered for CSI reporting from M sub-configurations provided to a UE, the CSI reporting is entirely omitted for the serving cell in uplink slot n′. If there is no valid downlink slot for the CSI reference resource corresponding to a CSI report setting in a serving cell, e.g., due to cell DTX off-durations, for any of the M sub-configurations provided to a UE or L sub-configurations triggered for CSI reporting from M sub-configurations provided to a UE, the CSI reporting is entirely omitted for the serving cell in uplink slot n′.

Alternatively, the CSI reporting is omitted for the serving cell in uplink slot n′ only for the reports associated with the sub-configurations, which do not have a valid downlink slot for the CSI reference resource. In this case, the UE provides a list of sub-configuration indexes omitted for CSI reporting or transmitted for CSI reporting. The indication of a list of sub-configuration indexes can be provided, e.g., using a bitmap of size M corresponding to M sub-configurations provided to a UE or using a bitmap of size L corresponding to L sub-configurations triggered for CSI reporting from M sub-configurations provided to a UE.

Alternatively, the UE does not provide a list of sub-configuration indexes omitted for CSI reporting, or transmitted for CSI reporting, but rather it is implicitly understood by the serving gNB by determining n_{CSI_ref} ref and the presence of a valid downlink slot for the CSI reference resource for each sub-configuration at the serving gNB.

Further alternatively, for periodic, semi-persistent and aperiodic CSI reporting with multiple sub-configurations, the CSI reference resource for a CSI reporting in uplink slot n′, n_{CSI_ref}, is determined per sub-configuration based on the conditions described in 3GPP standard specification for a CSI reporting with a single sub-configuration. Therefore, in this case, each sub-configuration triggered for CSI reporting may have different n_{CSI_ref}. Omission of CSI reports, which do not have a valid downlink slot for CSI reference resource, is decided and performed per sub-configuration basis. The UE provides a list of sub-configuration indexes omitted for CSI reporting, or transmitted for CSI reporting, as disclosed earlier.

In one example, whether the omission may be performed entirely or only for the reports associated with the sub-configurations, which do not have a valid downlink slot for the CSI reference resource is configured to the UE by the serving gNB.

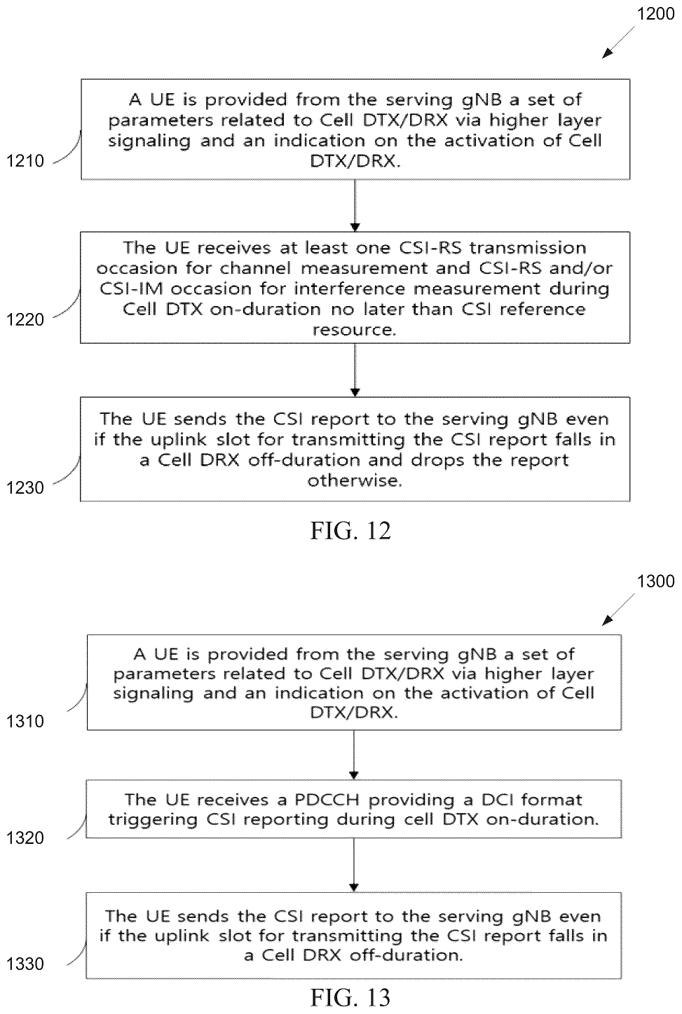

FIG. 12 illustrates a flowchart of a UE method 1200 for determining the transmission of CSI report during cell DRX off-duration according to various embodiments of the present disclosure. The UE method 1200 as may be performed by a UE (e.g., 111-116 as illustrated in FIG. 1). An embodiment of the UE method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

As illustrated in FIG. 12, in step 1210, a UE is provided from the serving gNB a set of parameters related to cell DTX/DRX via a higher layer signaling and an indication on the aviation of cell DTX/DRX. In step 1220, the UE receives at least one CSI-RS transmission occasion for channel measurement and CSI-RS and/or CSI-IM occasion for interference measurement during cell DTX on-duration no later than CSI reference resource. Otherwise, if the UE does no receive at least one CSI-RS transmission occasion for channel measurement and CSI-RS and/or CSI-IM occasion for interference measurement during cell DTX on-duration no later than CSI reference resource, CSI report is skipped. In step 1230, the UE sends the CSI report to the serving gNB even if the uplink slot for transmitting the CSI report falls in a cell DRX off-duration and drops the report otherwise.

For periodic, semi-persistent, or aperiodic CSI reporting, when a UE is signaled on the activation of cell DTX/DRX, the UE does not send the CSI report to the serving gNB, if the uplink slot for transmitting the CSI report falls in a cell DRX off-duration. In another example, if the UE receives at least one CSI-RS transmission occasion for channel measurement and CSI-RS and/or CSI-IM occasion for interference measurement during cell DTX on-duration no later than CSI reference resource, the UE sends the CSI report to the serving gNB even if the uplink slot for transmitting the CSI report falls in a cell DRX off-duration and drops the report otherwise.

In yet another example, the UE can be indicated by higher layer signaling from the serving gNB whether the UE sends the CSI report to the serving gNB if the uplink slot for transmitting the CSI report falls in a cell DRX off-duration or not, when the UE receives at least one CSI-RS transmission occasion for channel measurement and CSI-RS and/or CSI-IM occasion for interference measurement during cell DTX on-duration no later than CSI reference resource.

FIG. 13 illustrates a flowchart of a UE method 1300 for determining the transmission of aperiodic CSI report during cell DRX off-duration according to various embodiments of the present disclosure. The UE method 1300 as may be performed by a UE (e.g., 111-116 as illustrated in FIG. 1). An embodiment of the UE method 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

As illustrated in FIG. 13, in step 1310, a UE is provided from the serving gNB a set of parameters related to cell DTX/DRX via a higher layer signaling and an indication on the aviation of cell DTX/DRX. In step 1320, the UE receives a PDCCH providing a DCI format triggering CSI reporting during cell DTX on-duration. In step 1330, the UE sends the CSI report to the serving gNB even if the uplink slot for transmitting the CSI report falls in a cell DRX off-duration.

For aperiodic CSI reporting and semi-persistent CSI reporting on PUSCH, if the UE receives a PDCCH providing a DCI format triggering CSI reporting during cell DTX on-duration, the UE does not send the CSI report to the serving gNB, if the uplink slot for transmitting the CSI report falls in a cell DRX off-duration. In another example, if the UE receives a PDCCH providing a DCI format triggering CSI reporting during cell DTX on-duration, the UE sends the CSI report to the serving gNB even if the uplink slot for transmitting the CSI report falls in a cell DRX off-duration. In yet another example, the UE can be indicated by higher layer signaling from the serving gNB whether the UE sends the CSI report to the serving gNB if the uplink slot for transmitting the CSI report falls in a cell DRX off-duration, when the UE receives a PDCCH providing a DCI format triggering CSI reporting during cell DTX on-duration.

For a CSI report with CSI-ReportConfig including multiple sub-configurations with higher layer parameter reportQuantity not set to “none,” the CPU(s) are occupied for a number of OFDM symbols as follows. A periodic or semi-persistent CSI report (excluding an initial semi-persistent CSI report on PUSCH after the PDCCH triggering the report) occupies CPU(s) from the first symbol of the earliest one of each CSI-RS/CSI-IM/SSB resource for channel or interference measurement referred by any sub-configuration from the M sub-configurations provided to a UE or L sub-configurations triggered for CSI reporting from M sub-configurations provided to a UE, respective latest CSI-RS/CSI-IM/SSB occasion no later than the corresponding CSI reference resource, until the last symbol of the configured PUSCH/PUCCH carrying the report.

For a periodic CSI reporting, the number of sub-configurations triggered for CSI reporting may be identical to the number of sub-configurations provided to the UE, i.e., L-M. An aperiodic CSI report and an initial semi-persistent CSI report on PUSCH after the PDCCH trigger occupies CPU(s) from the first symbol after the PDCCH triggering the CSI report until the last symbol of the scheduled PUSCH carrying the report. When the PDCCH reception includes two PDCCH candidates from two respective search space sets, for the purpose of determining the CPU occupation duration, the PDCCH candidate that ends later in time is used.

For a CSI report configuration containing sub-configuration(s), if a CSI-RS resource is referred by K sub-configurations among the M sub-configurations provided to a UE for periodic or semi-persistent CSI report or L sub-configurations triggered for CSI reporting from M sub-configurations provided to a UE for aperiodic CSI report, the CSI-RS ports within the CSI-RS resource are counted by max(Σₛ₌₁^{K}Pₛ, P) for Type 1 SD adaptation, and K×P for Type 2 SD or PD adaptation, wherein P is nrofPorts configured in NZP-CSI-RS-Resource and Pₛ is the number of CSI-RS ports in sub-configuration s derived from port subset indication.

In another example, For Type 1 SD adaptation, Pₛ can be calculated as Nₛ^{CDM}·S^{CDM}, where Nₛ^{CDM} is a total number of CDM groups referred by port subset indication for sub-configuration s, and S^{CDM} is the size of CDM group of the referred CSI-RS resource. Therefore, Nₛ^{CDM}·S^{CDM} can be larger than or equal to the number of CSI-RS ports in sub-configuration s derived from port subset indication.

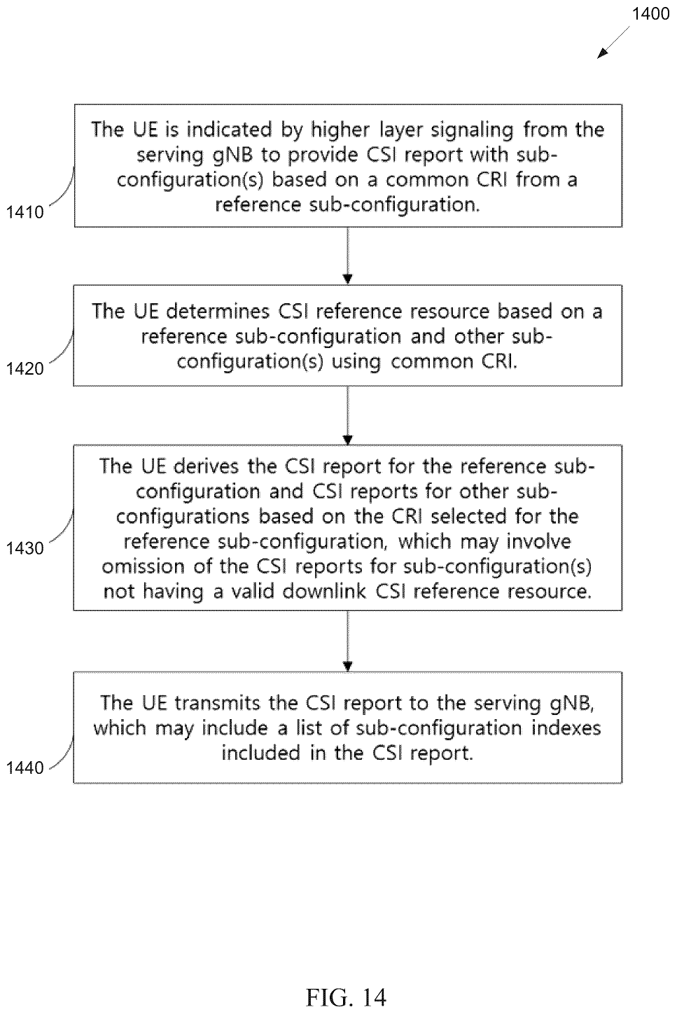

FIG. 14 illustrates a flowchart of a UE method 1400 for reporting CSI associated with sub-configurations based on a common CRI according to various embodiments of the present disclosure. The UE method 1400 as may be performed by a UE (e.g., 111-116 as illustrated in FIG. 1). An embodiment of the UE method 1400 shown in FIG. 14 is for illustration only. One or more of the components illustrated in FIG. 14 can be implemented in specialized circuitry configured to perform the noted functions or one or more of the components can be implemented by one or more processors executing instructions to perform the noted functions.

As illustrated in FIG. 14, in step 1410, a UE is indicated by a higher layer signaling from the serving gNB to provide CSI report with sub-configuration(s) based on a common CRI from a reference sub-configuration. In step 1420, the UE determines CSI reference resources based on a reference sub-configuration and other sub-configuration(s) using common CRI. In step 1430, the UE derives the CSI report for the reference sub-configuration and CSI reports for other sub-configurations based on the CRI selected for the reference sub-configuration. In step 1440, the UE transmits the CSI report to the serving gNB which may include a list of sub-configuration indexes included in the CSI report.

For a CSI report with multiple sub-configurations, the UE may be signaled to use common CRI for CSI reporting across L sub-configurations triggered for CSI reporting from M sub-configurations provided to a UE, wherein the number of sub-configurations triggered for CSI reporting may be identical to the number of sub-configurations provided to the UE for a periodic CSI reporting, i.e., L=M.

In one example, the UE selects the single CRI based on the CSI calculated for a reference sub-configuration indicated by the serving gNB, wherein the reference sub-configuration index may be explicitly provided to the UE or implicitly indicated, e.g., the first sub-configuration. In this example, the CPU occupancy can be counted as O_{CPU}=N₁ₛₜ+L−1, where N₁ₛₜ is the number of CSI-RS resources associated with the first sub-configuration.

For periodic and semi-persistent CSI reporting with sub-configuration(s), if a UE is signaled to report CSI based on a common CRI value, if multiple CSI-RS resources are configured for channel measurement in a reference sub-configuration for CRI derivation, the CSI reference resource for a CSI reporting in uplink slot n′, n_{CSI_ref}, in 3GPP standard specification is the smallest value greater than or equal to 9·2^{μ}^{_{DL}}, such that it corresponds to a valid downlink slot.

For aperiodic CSI reporting, if the UE is indicated by the DCI to report CSI in the same slot as the CSI request, n_{CSI_ref}, is such that the reference resource is in the same valid downlink slot as the corresponding CSI request, otherwise n_{CSI_ref} is the smallest value greater than or equal to └Z′/N_{symb}^{slot}┘, such that it corresponds to a valid downlink slot, wherein the value Z′ is calculated as the sum of the following two components as shown in TABLE 4.

TABLE 4
Components for sub-configuration

1. Z′ for reference sub-configuration

| | |
|---|---|
| a. | (Z₁, Z₁′) in 3GPP standard specification if the described conditions for using |
| | (Z₁, Z₁′) are met for the reference sub-configuration. |
| b. | (Z₂, Z₂′) in 3GPP standard specification if the described conditions for using |
| | (Z₁, Z₁′) and also (Z₃, Z₃′) are not met. |

2. Z′ for other sub-configurations based on a common CRI

| | |
|---|---|
| a. | (Z₁, Z₁′) in 3GPP standard specification if the described conditions for using |
| | (Z₁, Z₁′) are met for all the sub-configurations other than the reference sub- |
| | configuration. |
| b. | (Z₂, Z₂′) in 3GPP standard specification if the described conditions for using |
| | (Z₁, Z₁′) and also (Z₃, Z₃′) are not met for any sub-configuration other than |
| | the reference sub-configuration. |

For any CSI reporting type, if there is no valid downlink slot for the CSI reference resource corresponding to a CSI report setting in a serving cell for all the M sub-configurations provided to a UE or L sub-configurations triggered for CSI reporting from M sub-configurations provided to a UE, the CSI reporting is entirely omitted for the serving cell in uplink slot n′. If there is no valid downlink slot for the CSI reference resource corresponding to a CSI report setting in a serving cell for any of the M sub-configurations provided to a UE or L sub-configurations triggered for CSI reporting from M sub-configurations provided to a UE, the CSI reporting is entirely omitted for the serving cell in uplink slot n′.

Alternatively, if there is a valid downlink slot for the CSI reference resource for the reference sub-configuration, while there is no valid downlink slot for the CSI reference resource for any of the other sub-configurations based on a common CRI, the CSI for the reference sub-configuration is transmitted while the CSI reports for other sub-configurations based on a common CRI is entirely omitted. Further alternatively, the CSI reporting is omitted for the serving cell in uplink slot n′ only for the CSI reports associated with the sub-configurations, which do not have a valid downlink slot for the CSI reference resource. In this case, the UE provides a list of sub-configuration indexes omitted for CSI reporting, or transmitted for CSI reporting, as disclosed earlier.

In one example, whether the omission may be performed entirely, entirely for other sub-configurations based on a common CIR but not including the reference sub-configuration, or only for the reports associated with the sub-configurations, which do not have a valid downlink slot for the CSI reference resource is configured to the UE by the serving gNB.

For a CSI reporting using PUSCH, for Type I, Type II, enhanced Type II and further enhanced Type II port selection CSI feedback on PUSCH, a CSI report comprises of two parts. Part 1 has a fixed payload size and is used to identify the number of information bits in Part 2. Part 1 may be transmitted in its entirety before Part 2. For Type I CSI feedback, Part 1 contains RI (if reported), CRI (if reported), CQI for the first codeword (if reported). Part 2 contains PMI (if reported), LI (if reported) and contains the CQI for the second codeword (if reported) when RI is larger than 4. For Type II CSI feedback, Part 1 contains RI (if reported), CQI, and an indication of the number of non-zero wideband amplitude coefficients per layer for the Type II CSI. Part 2 contains the PMI and LI (if reported) of the Type II CSI. When CSI reporting on PUSCH comprises two parts, the UE may omit a portion of the Part 2 CSI. Omission of Part 2 CSI is according to the priority order shown in 3GPP standard specification. CSI report n corresponds to the CSI report with the nth smallest Prii,CSI(y, k, c, s) value among the N_{Rep} CSI reports as defined in 3GPP standard specification.

For type I CSI sub-band reporting on PUCCH formats 3, or 4, the payload is split into two parts. The first part contains RI (if reported), CRI (if reported), CQI for the first codeword. The second part contains PMI (if reported), LI (if reported) and contains the CQI for the second codeword (if reported) when RI>4. For CSI reports transmitted on a PUCCH, if all CSI reports consist of one part, the UE may omit a portion of CSI reports. Omission of CSI is according to the priority order determined from the Prii,CSI(y, k, c, s) value as defined in 3GPP standard specification. CSI report is omitted beginning with the lowest priority level until the CSI report code rate is less or equal to the one configured by the higher layer parameter maxCodeRate. If any of the CSI reports consist of two parts, the UE may omit a portion of Part 2 CSI. Omission of Part 2 CSI is according to the priority order shown in 3GPP standard specification. Part 2 CSI is omitted beginning with the lowest priority level until the Part 2 CSI code rate is less or equal to the one configured by higher layer parameter maxCodeRate.

For Part 2 sub-band CSI, if CSI report n includes multiple N sub-reports, all the odd sub-band CSIs of N sub-reports correspond to a same priority level, and all the even sub-band CSIs of N sub-reports correspond to another same priority level. For CSI report n including multiple N sub-reports, a UE performs CSI omission at a sub-report level from higher sub-report index to lower sub-report index starting from odd sub-band CSIs to even sub-band CSIs, wherein the even sub-band CSI omission starts after all the odd sub-band CSIs for N sub-reports are omitted for CSI report n.

For Part 2 wide-band CSI, all the N_{Rep} CSI reports are mapped to the same priority level 0, wherein some CSI report n may include Part 2 wide-band CSI for multiple sub-reports. In one example, Part 2 wide-band CSIs of all the N_{Rep} CSI reports are omitted entirely, i.e., all the information at that priority level 0. In another example, Part 2 wide-band CSIs are omitted at a report level from higher report index to lower report index, i.e., sub-priority level is defined within priority level 0 in the same way that the priority is determined using Prii,CSI(y, k, c, s) value as defined in 3GPP standard specification. If a certain sub-priority level within priority level 0 corresponds to a CSI report with N sub-reports, a UE performs CSI omission at a sub-report level from higher sub-report index to lower sub-report index.

Alternatively, a UE may omit Part 2 wide-band CSI corresponding to a CSI report with multiple sub-reports entirely. In yet another example, within priority level 0, Part 2 wide-band CSIs corresponding to a CSI report with multiple sub-reports are omitted first prior to any omission of Part 2 wide-band CSIs corresponding to a CSI report with single report. Among CSI reports with multiple sub-reports, the omission order is determined using Prii,CSI(y, k, c, s) value as defined in 3GPP standard specification. For a CSI report with N sub-reports, a UE performs CSI omission at a sub-report level from higher sub-report index to lower sub-report index.

Alternatively, a UE may omit Part 2 wide-band CSI corresponding to a CSI report with multiple sub-reports entirely. After omitting all the Part 2 wide-band CSIs corresponding to a CSI report with multiple sub-reports, the UE starts omitting Part 2 wide-band CSI corresponding to a CSI report with single report. The UE may omit the remaining Part 2 wide-band CSI of CSI reports with single report entirely. Alternatively, the UE may omit the remaining Part 2 wide-band CSI at a report level based on the priority level determined using Prii,CSI(y, k, c, s) value as defined in 3GPP standard specification.

For Part 1 CSI, in one example, omission is not allowed and the UE always entirely reports Part 1 CSI of all the N_{Rep} CSI reports. In another example, omission of Part 1 CSI is allowed and the UE either entirely reports or entirely omits Part 1 CSI of all the N_{Rep} CSI reports. In yet another example, Part 1 CSI is omitted at a report level from higher report index to lower report index, i.e., according to the priority determined using Prii,CSI(y, k, c, s) value as defined in 3GPP standard specification. In this case, if a Part 1 CSI of a certain CSI report includes multiple sub-reports, a UE performs CSI omission at a sub-report level from higher sub-report index to lower sub-report index.

Alternatively, the UE may omit Part 1 CSI corresponding to a CSI report with multiple sub-reports entirely. In further another example, Part 1 CSIs corresponding to a CSI report with multiple sub-reports are omitted first prior to any omission of Part 1 CSIs corresponding to a CSI report with single report. Among CSI reports with multiple sub-reports, the omission order is determined using Prii,CSI(y, k, c, s) value as defined in 3GPP standard specification. For a CSI report with N sub-reports, a UE performs CSI omission at a sub-report level from higher sub-report index to lower sub-report index. Alternatively, a UE may omit Part 1 CSI corresponding to a CSI report with multiple sub-reports entirely. After omitting all the Part 1 CSIs corresponding to a CSI report with multiple sub-reports, the UE starts omitting Part 1 CSI corresponding to a CSI report with single report. The UE may omit the remaining Part 1 CSI of CSI reports with single report entirely. Alternatively, the UE may omit the remaining Part 1 CSI at a report level based on the priority level determined using Prii,CSI(y, k, c, s) value as defined in 3GPP standard specification.

For CSI reports transmitted on a PUCCH, if all CSI reports consist of one part, the UE may omit a portion of CSI reports. Omission of CSI is according to the priority order determined from the Prii,CSI(y, k, c, s) value as defined in 3GPP standard specification. If a certain CSI report consists of N sub-reports, a UE performs CSI omission at a sub-report level from higher sub-report index to lower sub-report index. Alternatively, a UE may omit a CSI report with multiple sub-reports entirely.

For a UE operating in an NES-cell, the UE can be provided from the serving gNB RRC reconfiguration request indicating NES-CHO in addition to normal CHO. The normal CHO conditions are evaluated as soon as the UE receives an RRC reconfiguration message and performs handover to a target cell as soon as the indicated conditions are met by performing RACH transmission as provided by an RRC reconfiguration message. The NES-CHO conditions are evaluated as soon as the UE receives an RRC reconfiguration message while the execution of HO is delayed until receiving PDCCH providing DCI format 29 indicating cell DTX/DRX activation/deactivation or cell turning off. In one example, the UE periodically reevaluates NES-CHO conditions from when the UE receives an RRC reconfiguration message until the UE receives DCI format 2_9 indicating cell DTX/DRX activation/deactivation or cell turning off. In another example, the UE performs single evaluation of NES-CHO conditions when the UE receives DCI format 2_9 indicating cell DTX/DRX activation/deactivation or cell turning off.

The DCI format 2_9 may include single bit indication on cell turning off, which is common to all the UEs configured to monitor PDCCH providing DCI format 2_9 scrambled with cellDTRX-RNTI and the location of the field in the DCI 2_9 is indicated by the serving gNB or predefined by specifications of system operation. In another example, a location in DCI format 2_9 of a cell turning off indicator field for the serving cell is provided to the UE, which can be different from one UE to another UE monitoring PDCCH providing DCI format 2_9 scrambled with cellDTRX-RNTI.

The indication in DCI format 2_9 can be for “cell turning off,” “cell DTX/DRX activation,” or both for the purpose of triggering the “NES-CHO handover execution,” which is decoupled from the one- or two-bit indication on the activation/deactivation of cell DTX, DRX, or both.

In one example, the “NES-CHO handover execution” indication is common to all the UEs configured to monitor PDCCH providing DCI format 2_9 scrambled with cellDTRX-RNTI. In another example, “NES-CHO handover execution” indication is part of each information block in the DCI format 2_9, and the UE is provided the location of the information block for the UE to retrieve: Option 1) 1 bit (NES-CHO handover execution)+information block 1 (for cell DTX/DRX indication)+information block 2 (for cell DTX/DRX indication) . . . +information block N (for cell DTX/DRX indication); and Option 2) information block 1 (NES-CHO handover execution+cell DTX/DRX indication)+information block 2 (NES-CHO handover execution+cell DTX/DRX indication) . . . +information block N (NES-CHO handover execution+cell DTX/DRX indication).

The UE can be provided respective NES-CHO conditions for the activation of cell DTX/DRX and cell turning off.

Prior to or after transmitting PDCCH providing DCI format 2_9 indicating cell DTX/DRX activation/deactivation or cell turning off, the source cell can indicate to the target cell the transmission of PDCCH providing DCI format 2_9, which can be for example over Xn interface. The indication from the source cell to the target cell may include whether the DCI 2_9 indicated cell DTX/DRX activation/deactivation or cell turning off and the timing of indication.

Among the multiple NES-CHO target cells, the UE may be provided an order of priority to perform RACH transmission, if more than one target cells satisfy their respective NES-CHO conditions.

The UE can be also provided from the serving cell target cells' cell DTX/DRX activation/deactivation or cell turning off information, and the UE utilizes such information for performing measurements on the target cell. For instance, if a measurement occasion falls in a cell DTX off-duration or cell turning off time period, the UE does not perform corresponding measurements and also exclude for averaging the L1/L3 measurements.

Except for L1-SINR, if interference measurement is performed on NZP CSI-RS and a CSI-ReportConfig includes sub-configuration(s) providing a list of NZP CSI-RS resources for channel measurement, the UE can be configured with more than one NZP CSI-RS resources in the associated resource set within the resource setting for channel measurement, but the UE does not expect that, for any given sub-configuration, the list of NZP CSI-RS resources for channel measurement indicates more than one NZP CSI-RS resource for channel measurement. The UE can be provided nzp-CSI-RS-ResourcesForInterference configured in the CSI-ReportConfig or in each sub-configuration. If the UE is provided nzp-CSI-RS-ResourcesForInterference configured in the CSI-ReportConfig but not in a sub-configuration, the UE reports CSI for the sub-configuration based on the nzp-CSI-RS-ResourcesForInterference configured in the CSI-ReportConfig.

If the UE is provided nzp-CSI-RS-ResourcesForInterference configured in a sub-configuration, the UE reports CSI for the sub-configuration based on the nzp-CSI-RS-ResourcesForInterference configured in the sub-configuration. Except for L1-SINR, the UE configured with the higher layer parameter nzp-CSI-RSResourcesForInterference, either in CSI-ReportConfig or in a sub-configuration, may expect no more than 18 NZP CSI-RS ports configured in a NZP CSI-RS resource set.

Except for L1-SINR, if interference measurement is performed on NZP CSI-RS and a CSI-ReportConfig includes sub-configuration(s) providing higher layer bitmap parameter [port-subsetIndicator], a UE does not expect to be configured with more than one NZP CSI-RS resource in the associated resource set within the resource setting for channel measurement. In each sub-configuration, the UE is provided higher layer bitmap parameter [port-subsetIndicator] for each of the NZP CSI-RS provided in the nzp-CSI-RS-ResourcesForInterference configured in the CSI-ReportConfig.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method for a user equipment (UE) to report channel state information (CSI), the method comprising:
receiving:
first information related to one or more non-zero power CSI reference signals (NZP CSI-RSs) for channel measurement and one or more CSI-RSs or CSI interference measurements (CSI-RSs/CSI-IMs) for interference measurement on a cell;
second information related to a CSI report associated with a first number of CSI report sub-configurations, wherein:
the first number of CSI report sub-configurations are associated with a first number of subsets of the one or more NZP CSI-RSs for channel measurement, respectively, and
subsets in the first number of subsets of the one or more NZP CSI-RSs for channel measurement are identical or have no intersection;
third information related to indicating a second number of CSI report sub-configurations from the first number of CSI report sub-configurations, wherein the indication for second number of sub-configurations is explicit or implicit depending on a CSI report type; and
the one or more NZP CSI-RSs for channel measurement and the one or more CSI-RSs/CSI-IMs for interference measurement;
determining a second number of CSI sub-reports corresponding to the second number of CSI report sub-configurations, respectively, based on the second information, the third information, and the reception of the one or more NZP CSI-RSs for channel measurement and the one or more CSI-RSs/CSI-IMs for interference measurement; and
transmitting an uplink channel with the CSI report including the second number of CSI sub-reports.

2. The method of claim 1, further comprising:
determining a CSI processing unit (CPU) occupancy for a periodic CSI report,
wherein the CPU occupancy is counted from a first symbol of an earliest one of each NZP CSI-RS for channel measurement or CSI-RS/CSI-IM for interference measurement associated with the second number of CSI report sub-configurations, and
wherein the indication for the second number of CSI report sub-configurations is implicit and the second number of CSI report sub-configurations is identical to the first number of CSI report sub-configurations.

3. The method of claim 1, further comprising:
determining a CSI processing unit (CPU) occupancy for a semi-persistent CSI report,
wherein the CPU occupancy is counted from a first symbol of an earliest one of each NZP CSI-RS for channel measurement or CSI-RS/CSI-IM for interference measurement associated with the second number of CSI report sub-configurations, and
wherein the indication for the second number of CSI report sub-configurations is explicit and the second number of CSI report sub-configurations is identical to or less than the first number of CSI report sub-configurations.

4. The method of claim 1, further comprising:
determining, for a periodic CSI report, a CSI-RS port count for a CSI-RS from the one or more NZP CSI-RSs for channel measurement,
wherein the CSI-RS port count is determined as max(Σₛ₌₁^{K}Pₛ, P), where:
K is a number of sub-configurations associated with the CSI-RS from the second number of CSI report sub-configurations,
P is a number of CSI-RS ports configured for the CSI-RS, and
Pₛ is a number of CSI-RS ports from P indicated for s-th sub-configuration, and
wherein the indication for the second number of CSI report sub-configurations is implicit and the second number of CSI report sub-configurations is identical to the first number of CSI report sub-configurations.

5. The method of claim 1, further comprising:
determining, for a semi-persistent CSI report, a CSI-RS port count for a CSI-RS from the one or more NZP CSI-RSs for channel measurement,
wherein the CSI-RS port count is determined as max(Σₛ₌₁_{K}Pₛ, P), where:
K is a number of sub-configurations associated with the CSI-RS from the second number of CSI report sub-configurations,
P is a number of CSI-RS ports configured for the CSI-RS, and
Pₛ is a number of CSI-RS ports from P indicated for s-th sub-configuration, and
wherein the indication for the second number of CSI report sub-configurations is explicit and the second number of CSI report sub-configurations is identical to or less than the first number of CSI report sub-configurations.

6. The method of claim 1, wherein:
the CSI report includes two parts, and
a first of the two parts is transmitted entirely or dropped entirely.

7. The method of claim 1, further comprising:
receiving an indication to report a common CSI-RS resource indicator (CRI) for the second number of CSI report sub-configurations; and
determining the common CRI based on:
one or more sub-configurations from the second number of CSI report sub-configurations without an explicit indication, or
a reference sub-configuration with an explicit indication,
wherein transmitting the uplink channel with the CSI report further comprises transmitting the common CRI.

8. A user equipment (UE), comprising:
a transceiver configured to receive:
first information related to one or more non-zero power CSI reference signals (NZP CSI-RSs) for channel measurement and one or more CSI-RSs or CSI interference measurements (CSI-RSs/CSI-IMs) for interference measurement on a cell;
second information related to a CSI report associated with a first number of CSI report sub-configurations, wherein:
the first number of CSI report sub-configurations are associated with a first number of subsets of the one or more NZP CSI-RSs for channel measurement, respectively, and
subsets in the first number of subsets of the one or more NZP CSI-RSs for channel measurement are identical or have no intersection;
third information related to indicating a second number of CSI report sub-configurations from the first number of CSI report sub-configurations, wherein the indication for second number of sub-configurations is explicit or implicit depending on a CSI report type; and
the one or more NZP CSI-RSs for channel measurement and the one or more CSI-RSs/CSI-IMs for interference measurement; and
a processor operably coupled with the transceiver, the processor configured to determine a second number of CSI sub-reports corresponding to the second number of CSI report sub-configurations, respectively, based on the second information, the third information, and the reception of the one or more NZP CSI-RSs for channel measurement and the one or more CSI-RSs/CSI-IMs for interference measurement,
wherein the transceiver is further configured to transmit an uplink channel with the CSI report including the second number of CSI sub-reports.

9. The UE of claim 8, wherein:
the processor is further configured to determine CSI processing unit (CPU) occupancy for a periodic CSI report,
the CPU occupancy is counted from a first symbol of an earliest one of each NZP CSI-RS for channel measurement or CSI-RS/CSI-IM for interference measurement associated with the second number of CSI report sub-configurations, and
the indication for the second number of CSI report sub-configurations is implicit and the second number of CSI report sub-configurations is identical to the first number of CSI report sub-configurations.

10. The UE of claim 8, wherein:
the processor is further configured to determine a CSI processing unit (CPU) occupancy for a semi-persistent CSI report,
the CPU occupancy is counted from a first symbol of an earliest one of each NZP CSI-RS for channel measurement or CSI-RS/CSI-IM for interference measurement associated with the second number of CSI report sub-configurations, and
the indication for the second number of CSI report sub-configurations is explicit and the second number of CSI report sub-configurations is identical to or less than the first number of CSI report sub-configurations.

11. The UE of claim 8, wherein:
the processor is further configured to determine, for a periodic CSI report, a CSI-RS port count for a CSI-RS from the one or more NZP CSI-RSs for channel measurement,
the CSI-RS port count is determined as max(Σₛ₌₁^{K}Pₛ, P), where:
K is a number of sub-configurations associated with the CSI-RS from the second number of CSI report sub-configurations,
P is a number of CSI-RS ports configured for the CSI-RS, and
Pₛ is a number of CSI-RS ports from P indicated for s-th sub-configuration, and
the indication for the second number of CSI report sub-configurations is implicit and the second number of CSI report sub-configurations is identical to the first number of CSI report sub-configurations.

12. The UE of claim 8, wherein:
the processor is further configured to determine, for a semi-persistent CSI report, a CSI-RS port count for a CSI-RS from the one or more NZP CSI-RSs for channel measurement,
the CSI-RS port count is determined as max(Σₛ₌₁^{K}Pₛ, P), where:
K is a number of sub-configurations associated with the CSI-RS from the second number of CSI report sub-configurations,
P is a number of CSI-RS ports configured for the CSI-RS, and
Pₛ is a number of CSI-RS ports from P indicated for s-th sub-configuration, and
the indication for the second number of CSI report sub-configurations is explicit and the second number of CSI report sub-configurations is identical to or less than the first number of CSI report sub-configurations.

13. The UE of claim 8, wherein:
the CSI report includes two parts, and
a first of the two parts is transmitted entirely or dropped entirely.

14. The UE of claim 8, wherein:
the transceiver is further configured to receive an indication to report a common CSI-RS resource indicator (CRI) for the second number of CSI report sub-configurations;
the processor is further configured to determine the common CRI based on:
one or more sub-configurations from the second number of CSI report sub-configurations without an explicit indication, or
a reference sub-configuration with an explicit indication; and
the transceiver is further configured to transmit the common CRI.

15. A base station (BS), comprising:
a processor; and
a transceiver operably coupled with the processor, the transceiver configured to:
transmit first information related to one or more non-zero power CSI reference signals (NZP CSI-RSs) for channel measurement and one or more CSI-RSs or CSI interference measurements (CSI-RSs/CSI-IMs) for interference measurement on a cell;
transmit second information related to a CSI report associated with a first number of CSI report sub-configurations, wherein:
the first number of CSI report sub-configurations are associated with a first number of subsets of the one or more NZP CSI-RSs for channel measurement, respectively, and
subsets in the first number of subsets of the one or more NZP CSI-RSs for channel measurement are identical or have no intersection;
transmit third information related to indicating a second number of CSI report sub-configurations from the first number of CSI report sub-configurations, wherein the indication for second number of sub-configurations is explicit or implicit depending on a CSI report type;
transmit the one or more NZP CSI-RSs for channel measurement and the one or more CSI-RSs/CSI-IMs for interference measurement; and
receive an uplink channel with the CSI report including a second number of CSI sub-reports corresponding to the second number of CSI report sub-configurations, respectively, that are based on the second information, the third information, and the one or more NZP CSI-RSs for channel measurement and the one or more CSI-RSs/CSI-IMs for interference measurement.

16. The base station of claim 15, wherein:
a CPU occupancy for a periodic CSI report is counted from a first symbol of an earliest one of each NZP CSI-RS for channel measurement or CSI-RS/CSI-IM for interference measurement associated with the second number of CSI report sub-configurations, and
the indication for the second number of CSI report sub-configurations is implicit and the second number of CSI report sub-configurations is identical to the first number of CSI report sub-configurations.

17. The base station of claim 15, wherein:
a CPU occupancy for a semi-persistent CSI report is counted from a first symbol of an earliest one of each NZP CSI-RS for channel measurement or CSI-RS/CSI-IM for interference measurement associated with the second number of CSI report sub-configurations, and
the indication for the second number of CSI report sub-configurations is explicit and the second number of CSI report sub-configurations is identical to or less than the first number of CSI report sub-configurations.

18. The base station of claim 15, wherein:
a CSI-RS port count, for a periodic CSI report, for a CSI-RS from the one or more NZP CSI-RSs for channel measurement is determined as max(Σₛ₌₁^{K}Pₛ, P), where:
K is a number of sub-configurations associated with the CSI-RS from the second number of CSI report sub-configurations,
P is a number of CSI-RS ports configured for the CSI-RS, and
Pₛ is a number of CSI-RS ports from P indicated for s-th sub-configuration, and
the indication for the second number of CSI report sub-configurations is implicit and the second number of CSI report sub-configurations is identical to the first number of CSI report sub-configurations.

19. The base station of claim 15, wherein:
a CSI-RS port count, for a semi-persistent CSI report, for a CSI-RS from the one or more NZP CSI-RSs for channel measurement is determined as max(Σₛ₌₁^{K}Pₛ, P), where:
K is a number of sub-configurations associated with the CSI-RS from the second number of CSI report sub-configurations,
P is a number of CSI-RS ports configured for the CSI-RS, and
Pₛ is a number of CSI-RS ports from P indicated for s-th sub-configuration, and
the indication for the second number of CSI report sub-configurations is explicit and the second number of CSI report sub-configurations is identical to or less than the first number of CSI report sub-configurations.

20. The base station of claim 15, wherein:
the transceiver is further configured to:
transmit an indication to report a common CSI-RS resource indicator (CRI) for the second number of CSI report sub-configurations, and
receive the common CRI, and
the common CRI is based on:
one or more sub-configurations from the second number of CSI report sub-configurations without an explicit indication, or
a reference sub-configuration with an explicit indication.
